(19) United States
(12) Patent Application Publication
(10) Pub. No.: US 2002/0013948 A1
(43) Pub. Date: Jan. 31, 2002

(54) Video data management, transmission, and control system and method emloying distributed video segments microcasting

(76) Inventors: Erwin Aguayo JR., Columbia, MD (US); Angadbir (AB) Singh Salwan, Potomac, MD (US)

Correspondence Address: ZOLTICK TECHNOLOGY LAW GROUP, PLLC, Martin M. Zoltick, Loudoun Tech Center, 21515 Ridgetop Circle, Suite 200, Sterling, VA, 20166, US

(21) Appl. No.: 09/804,853

(22) Filed: Mar. 13, 2001

Related U.S. Application Data
(60) Provisional application No. 60/188,893, filed on Mar. 13, 2000.
(60) Provisional application No. 60/227,126, filed on Aug. 23, 2000.

(51) Int. Cl. H04N 7/173

(52) U.S. Cl. 725/91

(57) ABSTRACT

A system and method for video data management, transmission, and control employing distributed video segments microcasting (DVSM) is provided, said the system and method comprising: (i) video program sectoring facilitating video data storage; (ii) transforming video content to DVSM data format; (iii) ubiquitous transporting and high speed delivery of DVSM data; (iv) multi-level filtering and decision making for data assignment and coordination of critical user and DVSM video data; and (v) data insertion for inserting assigned user data into DVSM video data segments. The system and method for video data management, transmission, and control of the present invention uses a plurality of segmenting, formatting, distributing, microcasting, multicasting, high speed/low speed transmitting, asynchronous/isochronous transmitting, and resolution switching techniques to manage, transmit, and control video data. Any video data or program (analog or digital) can be converted to DVSM format for management, transmission, and control in accordance with the system and method of the present invention. The video data management, transmission, and control system and method of the present invention allows viewers to, instantly and without delay, view prerecorded, distributed and stored video programs, as well as live-broadcasts. Viewing will appear as if it had been broadcasted in real-time, as opposed to the delays associated with storing and downloading video programs. The system and method of the present invention allows users to, inter alia, control “who views which video” within the user's customer premise equipment (CPE) or in-home local area network (LAN). Users can stop, pause, replay, rewind or fast-forward any segment of the video program, including a live broadcast (with the exception of the fast-forward function), with a remote control. Users can also choose to view stored sub-titles for foreign video programs in the language of their choice.

### CROSS REFERENCE TO RELATED APPLICATION

This non-provisional application claims the benefit of the earlier filing dates of, and contains subject matter related to that disclosed in, U.S. Provisional Application Serial No. 60/188,893, filed Mar. 13, 2000, and U.S. Provisional Application Serial No. 60/227,126, filed Aug. 23, 2000, both having common inventorship, the entire contents of which being incorporated herein by reference.

### COPYRIGHT NOTIFICATION

Portions of this patent application contain materials that are subject to copyright protection. The copyright owner has no objection to the facsimile reproduction by anyone of the patent document, or the patent disclosure, as it appears in the Patent and Trademark Office.

### BACKGROUND OF THE INVENTION

1. Field of the Invention

The present invention relates, generally, to the field of video data management, transmission, and control and, more particularly, to a system and method for video data management, transmission, and control employing distributed video segments microcasting.

2. Discussion of the Background

Ever since the early Qube Cable TV experiments by Warner Amex Cable Communications, Inc. in the mid 1970's, efforts have been made by the communications and telecommunications industries to provide Interactive TV (iTV) and Video on Demand (VOD) services to viewers. Interactive TV is the process that allows viewers to interact and choose from a differentiated menu of programming content and to respond to (and with) specific requests for their participation by the program producer. VOD describes a type of service offered by video distributors that allows viewers to choose “when” and “what” they view. VOD eliminates the present practice of day-part content scheduling for “appointment television.” Various technologies have been invented and are currently being utilized that attempt to accomplish and provide iTV and VOD. However, these technologies have met with very little success.

Distributed Video Segments Microcasting (DVSM) technology provides a cost effective, fundamental or root technological solution for video distributors to ubiquitously offer iTV and VOD to any viewer, anywhere, anytime. Wireline as well as wireless networks can deploy DVSM technology. Cable TV operators, Telephone companies, Direct Broadcast Satellite, SMATV, MMDS, LMDS, and local Off-Air Television Broadcasters or any point to multipoint video distributor can utilize DVSM technology. Likewise, Internet Service Providers can utilize DVSM technology.

Presently these video and communications network operators are unsuccessfully utilizing a number of existing methods and technologies in an attempt to provide iTV and VOD services. All existing methods and technologies require extensive amounts of bandwidth, very powerful video servers and video streaming capacity to enable network operators to offer iTV, VOD and/or other interactive video services. DVSM greatly reduces the amount of bandwidth, server processing power and video transmission capacity needed to offer users iTV, VOD and other interactive services. In turn, the reduction of bandwidth, processing power and transmission capacity requirements makes it cost effective for network operators to offer these services.

A. Existing Technologies

At present, no existing technology is capable of providing high-resolution full-screen digital iTV and instantaneous VOD within acceptable performance parameters and cost considerations. Currently, video programming and, to the extent available, interactive TV services are delivered to viewers using the existing fundamental or base technologies and network technologies hereinafter described.

Analog video broadcasting is accomplished with a plurality of fixed bandwidth analog channels of 6 MHz each which are used to deliver video content in real-time. The 6 MHz bandwidth historically evolved from television broadcasting and is the standard channel width that is used in transmitting programming signals to today's television sets.

Digital video broadcasting is accomplished with a plurality of fixed bandwidth digital channels of 1 to 4 Mbps, each used to deliver video content to users. Advanced television sets and digital-to-analog television converters are in the process of being deployed with 1 to 4 Mbps bandwidth capacity.

Video streaming is a stream of isochronous video data (which is typically stored in a video server) that is transmitted in real-time from the video server to each client. The video server sends out one stream in response to every request sent by a client. The client receives, decodes, and displays the video on a TV/monitor in real-time. The streaming video data is temporarily stored in the client for display purposes only.

With video bursting, video data is stored in a central video server, similar to the technique used for video streaming. When a client sends a request, the central video server delivers video data in the form of ‘bursts’. These bursts are faster than real-time, and are temporarily stored in a client buffer. This stored data is then retrieved at a constant speed to display real-time video on the client's display or screen. The primary advantage of bursting technology over streaming is reduced number of interruptions in displaying full motion video due to network transmission errors.

HTTP downloading is accomplished when video data is down loaded from a central server on the Internet to a user's PC after the server receives a request. The user then has to wait until the download is complete, before viewing can begin.

B. Limitations of Existing Technologies

In video broadcasting, broadcasting technology was originally developed for one way distribution of video programs to everyone. The return-path from the viewer's home to the broadcasting station was never built within the network. As a result, interactive TV and VOD services are not possible with analog and digital broadcasting network technologies, since the same video program is transmitted to every user at a predetermined time by the broadcaster. Unlike multicasting, broadcasting technology does not have the ability to selectively deliver video programs to select viewers.

Video streaming and video bursting technologies are intended to deliver interactive TV and VOD services, but suffer from sever limitations as hereinafter described.

(1) Capacity Limitation of Centralized Systems

Video streaming and video bursting technologies are based on a central video server, which stores video programs, and delivers one real-time video stream to each client. The Video Server has a limited capacity to transmit a maximum number of video streams in real-time. For example, if one million viewers want to watch a high-resolution digital movie at different times of the day, the central server will need to have a real-time video streaming capacity of one million (3 Mbps) channels. None of the existing technologies has the capacity to meet such a heavy demand.

(2) Bandwidth Limitation of Shared Networks

All existing streaming and bursting technologies are designed to deliver real-time video streams over the Internet, cable, or a Local Area Network (LAN). These shared networks have a limited bandwidth, and other data traffic (such as large file transfers) further reduces the bandwidth available for high-resolution video content. With existing technologies, VOD is an economic improbability because the amount of bandwidth and transmission capacity requirement is directly related to the number of user requests multiplied by the required bandwidth per user. For example, if 2,000 viewers requested the same video (or different videos) simultaneously, or their requests were several minutes apart, the analog distributor would need 12,000 MHz and the digital distributor would need 2,000 MHz of spectrum. These requirements convert to 38.4 Gbps and 6.4 Gbps of bandwidth capacity. Fiber optic cable that could possibly be deployed to the curb ranges from DS1 with a 1.544 Mbps capacity to OC-48/48c with 2.4 Gbps capacity. In other words, provisioning 2,000 simultaneous or near simultaneous requests requires “fiber-to-the curb” to be deployed at a minimum capacity equal to OC-48/48c. Capacity limitations of affordable fiber optic cable within, say, the DS1 to OC-12/12c range would not have the nominal capacity to provide the users their requested video selections.

The system and method of the present invention, in contrast with these prior art technologies, enhances the capacity of the fiber cable by as much as 100 times, thereby enabling the use of OC-3/3c with 155 Mbps capacity and providing enough nominal capacity to provision all 2,000 requests with digital MPEG2 (3.2 Mbps) video transmission standard. Moreover, using DS3 fiber, the system and method of the present invention would provide enough capacity to provision the 2,000 users with MPEG1 (1.0 Mbps) quality video. (Fiber optic throughput rates are DS1—1.544 Mbps, DS3—44.786 Mbps, OC-3/3c—155 Mbps, OC-12/12c—622 Mbps, and OC-48/48c—2.4 Gbps.) Data rates for wireless, wireline or coaxial cable will vary depending on the size of the spectrum allocation or cable, and compression standards used in transmitting the video or video data. The dramatic improvement in performance enabled by the system and method of the present invention would be cost prohibitive in a system implemented using existing technologies.

(3) Transmission Errors

Video servers stream (or send bursts) video programs in real-time to clients. Any lost/corrupted video content data due to transmission errors result in program interruptions, since the client/server system with real-time isochronous transmission does not provision re-transmission of lost video data. The system and method of the present invention overcomes this limitation by transmitting asynchronous high-speed (faster than real-time) or low-speed (slower than real-time) data from video servers to client storage, and then re-transmitting real-time isochronous video data from client's storage to the viewer's screen or display.

HTTP download and view technology is not suitable for VOD applications since the downloading process is not isochronous, and the viewers have to wait for the complete download before they can begin viewing.

Thus, notwithstanding the available existing technologies, there is a need for a system and method (1) that is an enabling, root technology that provides a cost-effective, universal solution for the video distribution and telecommunications industries to offer high-resolution digital iTV, VOD, and other interactive video services to any viewer, anywhere, any time; (2) that overcome existing bandwidth issues, server processing power and streaming capacity issues, network-transmission problems, and other limitations of existing technologies; (3) that allows users to control “who views which video” within the user's customer premise equipment (CPE) or in-home local area network (LAN).

### SUMMARY OF THE INVENTION

The primary object of the present invention is to overcome the deficiencies of the prior art described above by providing a system and method that is an enabling, root technology that provides a cost-effective, universal solution for the video distribution and telecommunications industries to offer high-resolution digital iTV, VOD, and other interactive video services to any viewer, anywhere, any time.

Another key object of the present invention is to provide a video data management, transmission, and control system and method that overcomes existing bandwidth issues, server processing power and streaming capacity issues, network-transmission problems, and other limitations of existing video broadcasting, streaming, bursting, and http downloading technologies.

Yet another key object of the present invention is to provide a video data management, transmission, and control system and method that enables instantaneous delivery of high-resolution full motion digital video programs for interactive TV (iTV), video-on-demand (VOD), and other interactive video services.

Still another key object of the present invention is to provide a video data management, transmission, and control system and method that allows users to control “who views which video” within the user's customer premise equipment (CPE) or in-home local area network (LAN).

Another key object of the present invention is to provide a video data management, transmission, and control system and method that enables video programs to be delivered through cable television or wireline and/or wireless communications networks without the need and use of extensive bandwidth, video server processing power, and video transmission capacity.

Yet another key object of the present invention is to provide a video data management, transmission, and control system and method that resolves the bandwidth, video server processing power, and streaming capacity and transmission error issues associated with offering users a large array of video programming selections.

Another key object of the present invention is to provide a video data management, transmission, and control system and method that can logarithmically reduce the amount of spectrum and cost associated with spectrum needed to provide users their video selections.

Another key object of the present invention is to provide a video data management, transmission, and control system and method that can overcome the limitations of existing video streaming technologies, and reduce the network bandwidth requirements for transmitting video on demand and interactive television by utilizing segmenting, multicasting, and distributing techniques.

Still another key object of the present invention is to provide a video data management, transmission, and control system and method that can distribute and reduce the computer processing power needed to provide video on demand and interactive television.

Another key object of the present invention is to provide a video data management, transmission, and control system and method that can dynamically manage video segments transmission and, thereby, bandwidth allocations without the need for extensive video transmission capacity.

Another object of the present invention is to provide a video data management, transmission, and control system and method that transform the conventional video streaming process from a video domain to a data domain.

Yet another key object of the present invention is to provide a video data management, transmission, and control system and method that can deliver individualized program content to users.

The present invention achieves these objects and others by providing a system and method for video data management, transmission, and control employing distributed video segments microcasting, the system and method comprising: (i) video program sectoring facilitate video data storage; (ii) transforming video content to DVSM data format; (iii) ubiquitous transporting and high speed delivery of DVSM data; (iv) multi-level filtering and decision making for data assignment and coordination of critical user and DVSM video data; and (v) data insertion for inserting assigned user data into DVSM video data segments. The video data management, transmission, and control system and method of the present invention allows viewers to, instantly and without delay, view prerecorded, distributed and stored video programs, as well as live-broadcasts. Viewing will appear as if it had been broadcasted in real-time, as opposed to the delays associated with storing and downloading video programs. The system and method of the present invention allows users to, inter alia, control “who views which video” within the user's customer premise equipment (CPE) or in-home local area network (LAN). Users can stop, pause, replay, rewind or fast-forward any segment of the video program, including a live broadcast (with the exception of the fast-forward function), with a remote control. Users can also choose to view stored sub-titles for foreign video programs in the language of their choice.

More specifically, the system and method for video data management, transmission, and control employing distributed video segments microcasting of the present invention uses a plurality of segmenting, formatting, distributing, microcasting, multicasting, high speed/low speed transmitting, asynchronous/isochronous transmitting, and resolution switching techniques to manage, transmit, and control video data. Any video data or program (analog or digital) can be converted to DVSM format for management, transmission, and control in accordance with the system and method of the present invention.

In a preferred embodiment of the system and method of the present invention, analog video is digitized, and the digital video content is divided into video segments of variable lengths. The digital video segments are formatted using a formatting process that assigns attributes to each video segment based upon its characteristics, such as the video content-type, motion content within the segment, and its suitability for ad insertion. A number of attributes are assigned to user data, segmented video content data, and video advertisement data to automate the coordination and insertion of critical user information with video selections. Segmented video data and user data is distributed and stored throughout the cable TV, wireline or wireless communications network components to maximize the number of offerings that can be made by the network operator. Video segments of a program are distributed and stored at different levels within the network. By distributing the storage of video segments across the network within many servers, the transmission of a video program to the client can begin immediately after the viewer request is received. While the viewer is watching the initial program segments stored at the client, remaining segments are transmitted at higher speed from different network servers to the client. This process overcomes the streaming capacity limitation of the existing centralized technology, as well as the delay associated with the HTTP downloading technology.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

A more complete appreciation of the invention and many of the attendant advantages thereof will be readily obtained as the same becomes better understood by reference to the following detailed description when considered in connection with the accompanying drawings, wherein:

FIG. 1 is a representation of bandwidth requirements of conventional video streaming verses the bandwidth requirements of a system and method according to the present invention.

FIG. 2 is a representation of the dynamic relationship between the number of users, the number of selections, the number of users per selection and the bandwidth requirements, and the logarithmic cost-benefit relationship associated with a system and method according to the present invention.

FIG. 3 is a graphical illustration of how the system and method according to the present invention dynamically assigns a number of users' IP addresses to a previously selected video and its segments that are being transmitted.

FIG. 4 is a graphical illustration of the effects on bandwidth requirements of the dynamic multicasting techniques of the system and method according to the present invention.

FIG. 5(a) is a functional block diagram of the segmenting and formatting process of the system and method according to the present invention.

FIG. 5(b) is an illustration of the attributes found within the segmenting and formatting process and how these attributes are created and organized in a preferred embodiment of the system and method according to the present invention.

FIG. 6(a) is an illustration in block diagram form that illustrates a comparison between the real-time isochronous transmissions of prior art streaming video technologies, and the isochronous transmission of prior art video bursting technology.

FIG. 6(b) is an illustration in block diagram form that illustrates the two different modes of data transfer according to a preferred embodiment of the system and method of the present invention.

FIG. 7 is a functional block diagram of the architecture for the video data storage system according to a preferred embodiment of the system and method of the present invention.

FIG. 8 is a more detailed functional block diagram of the data storage system illustrated as level 1 in the architecture for the system and method according to a preferred embodiment of the present invention of FIG. 7.

FIG. 9 is a more detailed functional block diagram of the data storage illustrated as levels 2 to (z-2) in the architecture for the system and method according to a preferred embodiment of the present invention of FIG. 7.

FIG. 10 is a more detailed functional block diagram of the data storage level illustrated as level (Z-1) in the architecture for the system and method according to a preferred embodiment of the present invention of FIG. 7.

FIG. 11 is a more detailed functional block diagram of the data storage level illustrated as level Z in the architecture for the system and method according to a preferred embodiment of the present invention of FIG. 7.

FIG. 12 is an illustration in block diagram form of the programming steps necessary to carry out the basic microcasting operation of the algorithm for the client software according to a preferred embodiment of the system and method of the present invention.

FIG. 13 is an illustration in block diagram form of the programming steps necessary to carry out the basic microcasting operation of the algorithm for the network software according to a preferred embodiment of the system and method of the present invention.

FIG. 14 is an illustration in block diagram form of the programming steps necessary to carry out the basic dynamic resolution switching operation of the algorithm for the network software according to a preferred embodiment of the system and method of the present invention.

FIG. 15 is a functional block diagram of the global architecture for the system for the metro media centers according to a preferred embodiment of the system and method of the present invention.

FIG. 16 is a block diagram representing the connections between a metro media center and a plurality of distribution and control sites according to a preferred embodiment of the system and method of the present invention.

FIG. 17 is a flow diagram representing the bi-directional flow of data through a metro media center system for voice, video and data transmission according to a preferred embodiment of the system and method of the present invention.

FIG. 18 is a block diagram representing a plurality of connections between a distribution and control site and a plurality of homes according to a preferred embodiment of the system and method of the present invention.

FIG. 19 is a flow diagram representing the bidirectional flow of data through the distribution and control site architecture of the system for voice, video and data communications according to a preferred embodiment of the system and method of the present invention.

FIG. 20 is a block diagram representing the interface for the voice, video and data gateway module in the system and method of a preferred embodiment of the present invention as shown in FIG. 11.

### DETAILED DESCRIPTION OF THE PREFERRED EMBODIMENTS

In the following description, for purposes of explanation and not limitation, specific details are set forth, such as particular networks, communication systems, computers, terminals, devices, components, techniques, data and network protocols, software products and systems, enterprise applications, operating systems, enterprise technologies, middleware, development interfaces, hardware, etc. in order to provide a thorough understanding of the present invention. However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, enterprise applications, operating systems, enterprise technologies, middleware, development interfaces, and hardware are omitted so as not to obscure the description of the present invention.

I. General System Overview and Design Concepts

A. General System Overview

(1) System Architecture

The Video Data Management, Transmission, and Control System and Method of the present invention is comprised of the following network architectures and components:

(1) Global DVSM network architecture;

(2) Metro DVSM network architecture;

(3) Metro Media Center (MMC) including MMC voice, video, and data (VVD) architecture;

(4) Community DVSM network architecture;

(5) Distribution and Control Site (DCS) including DCS VVD architecture;

(6) Community Relay Switch (CRS);

(7) Home DVSM network architecture;

(8) Customer Premises Equipment (CPE);

(9) DVSM Server; and

(10) DVSM Client (Media Navigator).

Each of these network architectures and components are explained in greater detail below. The mode of communication and transmission of data (e.g., satellite, satellite dish, fiber link, directional antenna, packet-switched line, wireless link, micro trunk line, circuit-switched line, packet-shared line, home wireless data link, VVD wireless link, and analog telephone line) between the components comprising the various network architectures is also explained.

(2) D VSM Formatting Process

DVSM moves video from its video domain to a data domain by altering the fundamental structure of the video itself. A video program (analog or digital) is first converted to DVSM format. A stream of video is digitized and converted to “independent” data segments of variable lengths that contain their own distinct DNA, resulting in each segment becoming standalone data with a set of attributes that provide the information of what the data is supposed to do independently of what is contained in other segments. The DVSM formatting process assigns attributes to each video segment based upon its characteristics, such as, the video content-type, motion content within the segment, and its suitability for ad insertion. A number of DVSM attributes are assigned to user data, segmented video content data, and video advertisement data to automate the coordination and insertion of critical user information with video selections. For example, segments can be dynamically assigned to specific scenes, removed from scenes, instructed to be displayed in a specific sequence, “independently” viewed, launched from another segment, or sent to a number of client addresses. A more detailed explanation of the DVSM formatting process is set forth below.

(3) DVSM Segmentation Process

Segmented video data and user data are then distributed and stored throughout the cable TV, wireline or wireless communications network components to maximize the number of offerings that can be made by the network operator. Video segments of a program can be distributed and stored at different levels within the network. By distributing the storage of video segments across the network within many DVSM Servers, the transmission of a video program to the DVSM Client can begin immediately after the viewer request is received. While the viewer is watching the initial program segments stored at the DVSM Client, remaining segments are transmitted at higher speed from different DVSM Servers to the DVSM Client. This process overcomes the Streaming Capacity Limitation of the existing centralized technology, as well as the delay associated with the HTTP Downloading technology.

To allow video content producers and distributors to sell advertising or other programming on a highly segmented basis, video-clip ads are dynamically assigned to program video segments based on users' particular psychodynamic and demographic profiles.

A more detailed explanation of the DVSM segmentation process is set forth below.

(4) Microcasting

Microcasting is the technical process used to deliver selective segments of a video program directly associated with each individual viewer's interactive request-type, stated or unstated wants, wishes, desires, psychodynamic and demographic needs. Embedded within the microcasting technology are multi-level filtering, decision making and dynamic data insertion techniques that collectively deliver highly individualized video programming content without the need for excessive bandwidth. For example, if, in a movie, the hero is driving a BMW sports car, the microcasting process will automatically search the user's profile and, if the user has expressed an interest in sport cars, the system will launch a video advertisement for a BMW. Video advertisements or other programming may also be launched based on default attributes associated with the movie. In another example, if the viewer is a 13-year-old child requesting to watch a movie, the microcasting process will automatically search the appropriate authorizations assigned by the parents, and restrict video programs containing “violence and adult content” based on those authorizations. It will also insert only those advertisements that are suitable for 13-year-old children, boy or girl, and particularly match the wants and needs of the child watching the movie.

Commonly the word “micro” is defined as 1) small or 2) denoting a factor of one millionth (10⁻⁶). In other contexts, micro is used to describe the reduction in size or miniaturization of some item, system or device. We hear and use the word micro in a combined form such as microchip, microcomputer, microprocessor, microanalysis, microfilm and microcircuit. These words and many more are common and well defined in communications, computing, and engineering and in the community at large. The common uses of the word “micro” in various combinations give us a sense of what something may mean but does not make its meaning obvious. When the public hears the word microcasting, it will likely ascribe certain attributes or characteristics to its meaning. Microcasting, as a word, is presently not defined in the English language or in the engineering or scientific community. As explained in greater detail below, in the context of the present invention “microcasting” is the technical process used to deliver selective segments of a video program directly associated with each individual viewer's interactive request-type, stated or unstated wants, wishes, desires, psychodynamic and demographic needs. A more detailed explanation of the microcasting process is set forth below.

(5) Dynamic Multicasting

Multicasting is a commonly used technique for data networks whereby multiple user addresses are assigned to a particular data packet (or a set of data packets) before transmission. DVSM overcomes the limitation of streaming technology by dividing a lengthy video program into smaller video segments, and dynamically assigning multiple user addresses to synchronize user requests with video segment transmissions, thus providing real-time video on demand. Within the DVSM environment, multicasting techniques are used to dynamically increase the number of users assigned to a video selection segment irrespective of when the user may have made the selection. Video segments are transmitted in appropriate time frames and order. Once a particular video is selected, its segments are immediately released. The segments can be released in sequence—i.e., segment one is released, then segment two, then segment three and so forth—or the segments can be released in some other order. Should another user request the same video selection after a short interval, the first segment is immediately released and the user's IP address is assigned to any other segments that are being released of the same video. Appropriate individual segments are released to the second user or third or fourth users until the only remaining segments are assigned multiple addresses. DVSM can dynamically assign a number of users' IP addresses to a previously selected video and its segments that are being transmitted. As each subsequent video segment is transmitted, user IP addresses are dynamically added to the assigned transmission of a particular video segment that has been requested by new users. A more detailed explanation is set forth below.

(6) DVSM High-Speed and Low-Speed Video Transmission

DVSM allows networks to transmit high-speed (faster than real-time) single channel, or low-speed (slower than real-time) multi-channel asynchronous video frames from the DVSM Server to the Storage inside the DVSM Client, and isochronous transmission from the DVSM client to the video display. Since the video display is local to the DVSM Client, any short network transmission delays do not interrupt the delivery of smooth video. This hybrid data transmission technique also increases the network efficiency, since the DVSM Server can dynamically allocate the available network bandwidth to its active Clients to assure uninterrupted video display. A more detailed explanation is set forth below.

(7) Dynamic Resolution Switching

Dynamic Resolution Switching (DRS) is the technique used by DVSM Server software to ensure uninterrupted video transmissions to all the users during a time interval when the available bandwidth is not sufficient to meet peak demand. The DRS algorithm uses inputs from variables and buffers dynamically updated by the Multicasting algorithm. The first process examines the status of these variables and buffers, and estimates available bandwidth to transmit the next batch of video segments. If the estimated bandwidth is not enough, the Bandwidth flag is set, which initiates the next process. The addresses of clients with active requests are extracted, and client service priorities are examined. The clients with lowest priority are selected and grouped together. At the end of current segment transmission, the selected clients are switched over for lower resolution transmission. The process is repeated to meet the demand of all pending client requests. After reaching a balanced state of video transmission for all the active clients, the next process starts examining relevant variables and buffers, and estimates available bandwidth to determine if a switchback to higher resolution is possible. If so, the Bandwidth flag is reset, and the next process begins to examine the active clients and their service priorities. The highest priority clients are switched back to higher resolution transmission, followed by the next batch of clients until a balanced condition is reached. These processes continue working in synchronization with the polling loop timer of the multicasting algorithm. A more detailed explanation of the dynamic resolution switching process is set forth below.

B. Design Concepts

The video data management, transmission, and control system and method of the present invention employs a number of techniques that take advantage of certain naturally occurring phenomena. These phenomena range from basic physics to social behaviors.

One of the natural social phenomena pertaining to video viewing is selection ratio. The selection ratio is defined by the invention as the number of viewers who select a particular video at the same or about the same time frame but not simultaneously. For example, if on average, 50 customers selected the same video, the selection ratio would be 50:1. If on average, 10 customers selected the same video the selection ratio would be 10:1, 20 customers are equal to 20:1 ratio and so forth.

Selection ratios are behavioral dynamics that occur because of many variables, not the least of which are the actions or inaction of video programming content producers or the quality of the video content itself. For a number of reasons, consumers prefer certain content over others. The popularity of video content is measured everyday in movie theaters, in the TV ratings system and in video stores throughout the world.

In the context of providing real-time video on demand, the invention capitalizes on this naturally occurring phenomenon while video-streaming technology remains silent. With video streaming technology, the bandwidth needed to transport video is directly proportional to the number of active users, with no relationship to the number of different videos being requested. A separate copy of a requested video is made for each request and a separate transmission of each generated copy is initiated. This means that for every viewer placing a request, a specific and consistent amount of bandwidth capacity is needed regardless of the number of viewers that may have selected a particular video or a plurality of videos. Once the network begins transmitting a video stream, it cannot be interrupted. New viewers requesting the same video receive their selection using more of the remaining bandwidth and server capacity.

In the context of providing real-time video on demand, the invention capitalizes on this naturally occurring phenomenon while video-streaming technology remains silent. With video streaming technology, the bandwidth needed to transport video is directly proportional to the number of active users, with little or no relationship to the number of different videos being requested. A separate copy of a requested video is made for each request and a separate transmission of each generated copy is initiated. This means that for every viewer placing a request, a specific and consistent amount of bandwidth capacity is needed regardless of the number of viewers that may have selected a particular video or a plurality of videos. Once the network begins transmitting a video stream, it cannot be interrupted. New viewers requesting the same video receive their selection using more of the remaining bandwidth and server capacity.

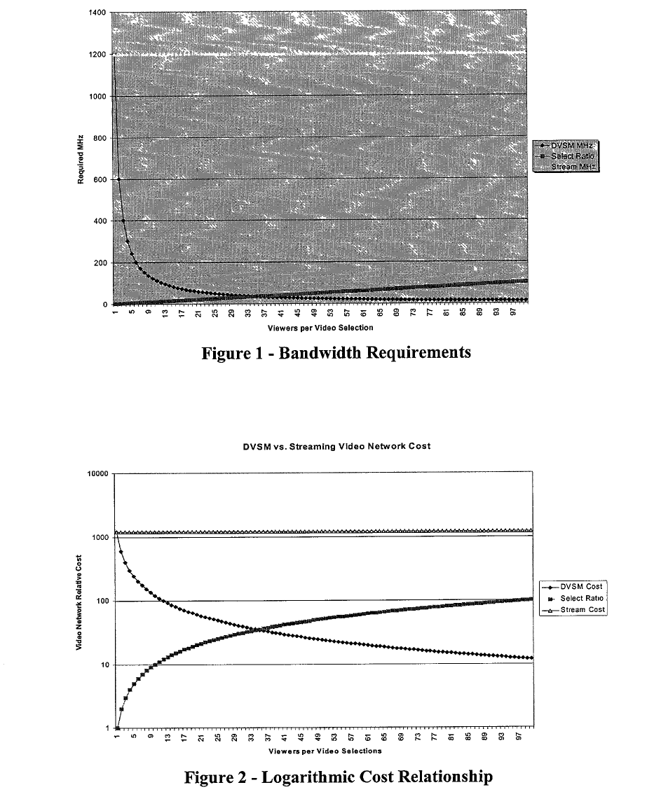

FIG. 1 illustrates the comparative bandwidth requirements for both the invention and other streaming video technologies, as related to the selection ratio up to 100 (12% of total viewers) for a group of 1200 viewers. As the selection ratio increases, the invention's bandwidth requirement drops exponentially while video streaming bandwidth requirement remains constant at 1,200 MHz. Bandwidth requirements are geometrically reduced using its embedded segmenting, multicasting and distributing techniques while video streaming bandwidth requirements remain constant at 1,200 MHz irrespective of the selection ratio. A selection ratio of 2:1 reduces bandwidth requirements by as mush a 50%. The numbers on the X-axis represent the number of viewers per video and the numbers on the Y-axis represent the spectrum requirements in MHz. The darkest line represents the invention's bandwidth requirements; the lightest line represents the bandwidth requirements for video streaming. The shaded line represents the increase in numbers of viewers per video. This illustration is limited to a selection ratio of 100:1, which only represents, on average, 8.3% of the entire 1,200-viewer universe and is not meant to be predictive. Actual results are affected by many variables and may result in selection rations +/−100:1 depending on the number of video selections. Typically 80% of viewer requests are spread over the top 200 titles.

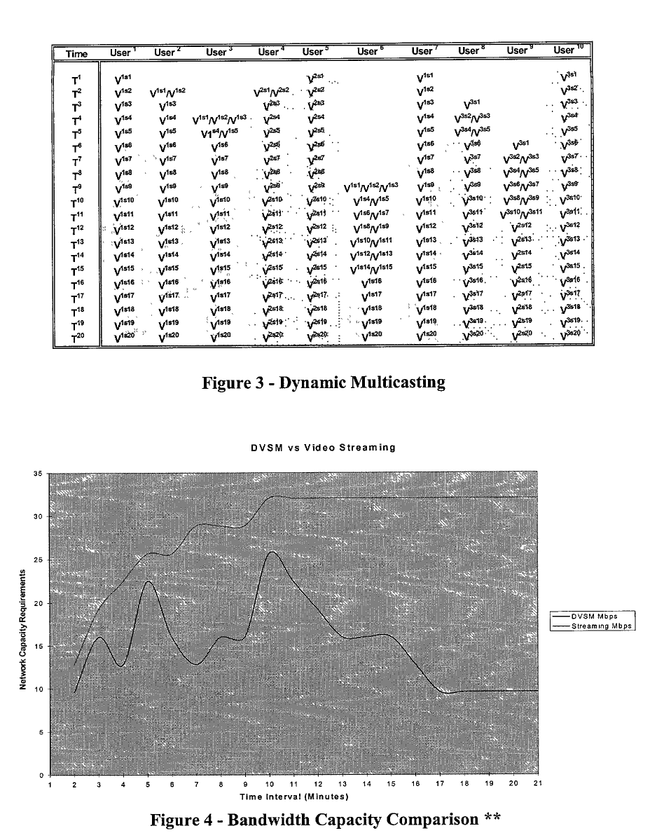

Reduced bandwidth requirement results in reduction of video equipment & network cost, as shown in FIG. 2. Multicasting techniques, other techniques and various elements of the invention create a dynamic relationship between the number of users, the number of selections, the number of users per selection and the bandwidth requirements thus the cost needed to provision interactive video on demand to the largest number of users possible. This relationship is logarithmic. As the number of users per selection increases, the amount of spectrum and cost needed to provide these users their selections decreases.

In the FIG. 2, the straight jagged line represents costs associated with streaming video deployment as they relate to the selection ratios illustrated by the upward lighter curved line and the numbers on the X-axis. The dark downward curved line illustrates costs associated with the invention as they relate to the selection ratios illustrated by the upward lighter curved line and the numbers on the X-axis.

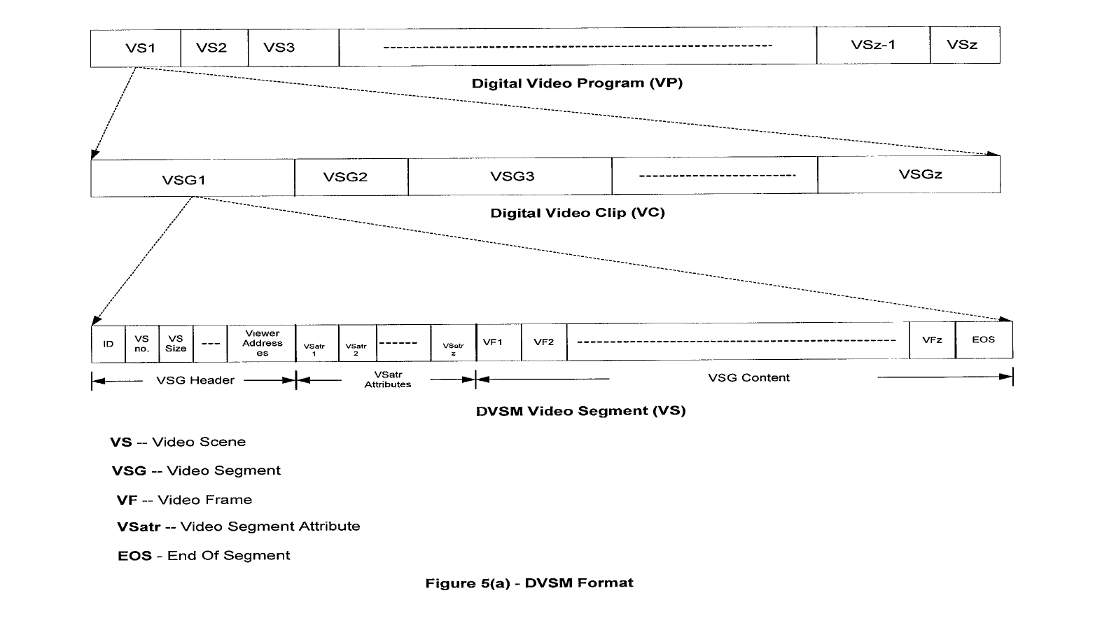

FIG. 3 illustrates how the invention can dynamically assign a number of users' IP addresses to a previously selected video and its segments that are being transmitted. In the illustration there are 10 users, who have selected three different videos, which are being transmitted over 20-minute time intervals designated T¹ through T²⁰. At the first time interval T¹, Video¹ was selected by User¹ and User⁷. Simultaneously at T¹ Video² was selected by User⁵ and Video 3 was selected by User¹⁰. Four of the 10 users made their selections. One minute thereafter at time interval T², User² selected Video¹ and User⁴ selected Video². There are now 5 users viewing their 3 selections. DVSM transmits segment V^{1s2} to User¹, User⁷ and User² who also receives segment V^{1s1}. User⁴ receives segment V2s1 and segment V2s2, which is also transmitted to User¹⁰. The process continues until all users are receiving the video that they selected. As each subsequent video segment is transmitted user IP addresses are dynamically added to the assigned transmission of a particular video segment that has been requested by new users.

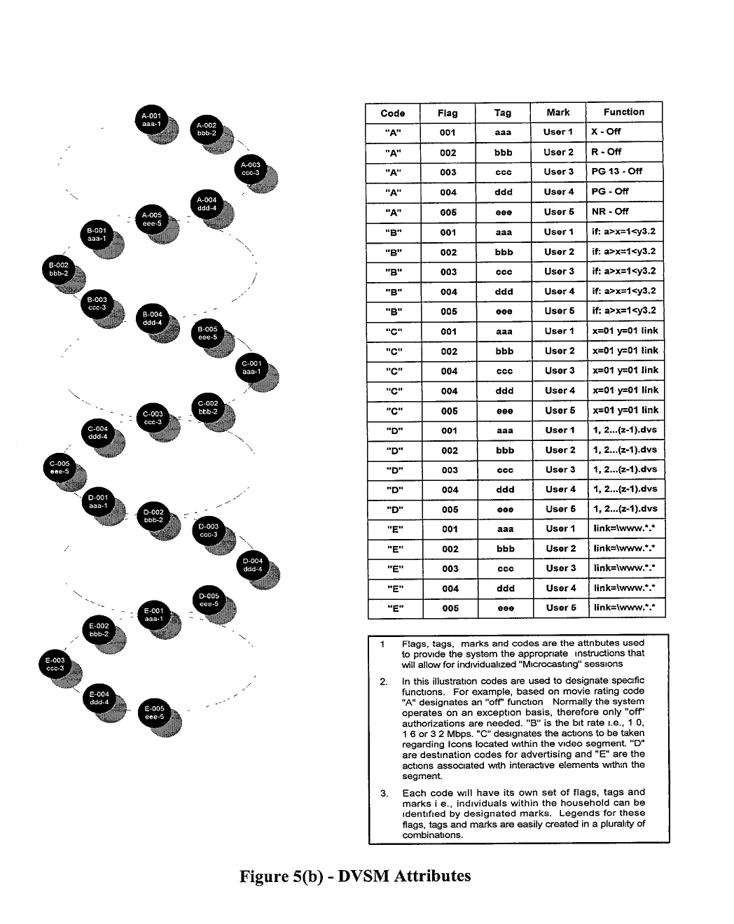

In this example, the effects of dynamic multicasting on bandwidth requirements are illustrated in FIG. 4 where, the lower darker line represents the bandwidth capacity requirements of the invention and the upper lighter line represents the bandwidth requirements of video streaming. On the X-axis the time intervals are represented and on the Y-axis capacity requirements for both the invention and video streaming are represented in Mbps. Within this example, the entire process took 20 minutes. Ten users selected 3 different videos at different times. The delta between the top video streaming line and the lower DVSM line shows a bandwidth capacity enhancement of over 300%.

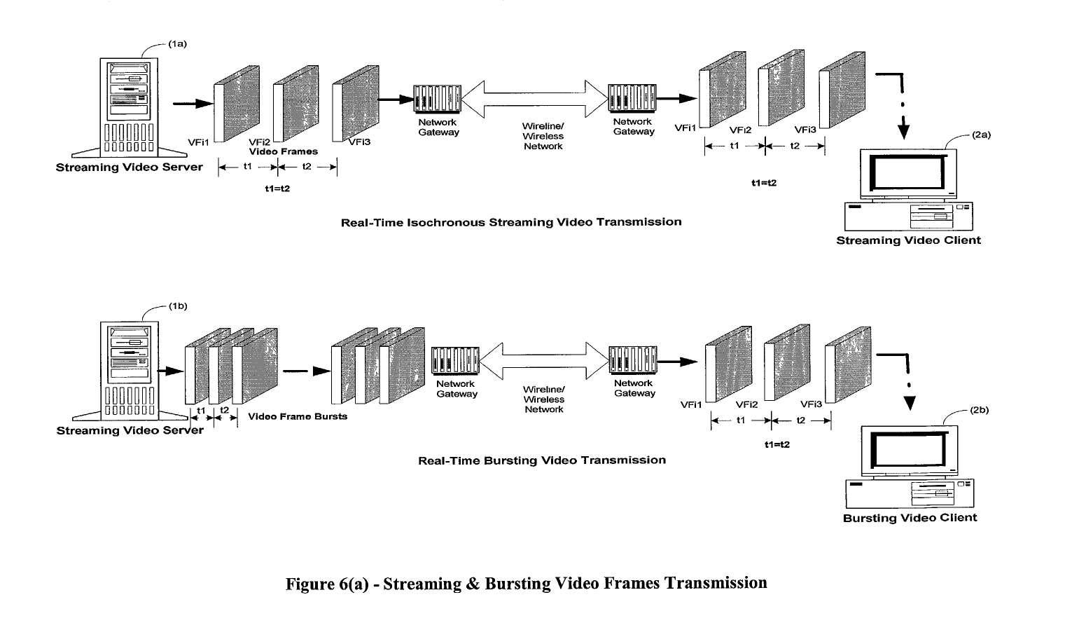

FIG. 5(a) illustrates formatted video as conceptualized by the invention. To begin with, the invention moves video from its video domain to a data domain. This is accomplished by altering the fundamental structure of the video itself. A stream of video is digitized and converted to independent data segments that contain their own distinct instructions and tests similar to DNA. This process, in and of it-self, is vastly different from the existing state of the art; in-that each segment becomes standalone data. In other words each segment has a set of attributes that provide the information of what the data is supposed to do independently of what is contained in other segments. For example segments can be dynamically assigned to specific scenes, removed from scenes, instructed to a specific sequence, independently viewed or sent to a number of client addresses.

In the data domain, the system and method of the present invention has the flexibility to dynamically manage who, what, where, when and how a video segment relates to its transmission, external-protocols, affiliated video segments, and/or other unaffiliated segments such as fixed or transient data segments. The major advantage of moving video to the data domain is that its transmission can be dynamically and better managed exponentially reducing bandwidth requirements. In the Video domain, video streaming requires a certain amount of constancy and conformity to provide a consistent picture and minimize transmission errors. Transmissions are conducted isochronously.

In the data domain, the system and method of the present invention can use asynchronous transmissions between the server and its clients providing the opportunity to release segments at variable speeds within allocated spectrum. This way transmission speeds can be and are many times greater than viewing speeds and segments can be dynamically (on the fly) assigned to a number of clients resulting in a quicker delivery to more viewers.

Microcasting is the process of associating and assigning certain video segments (not entire video streams) with specific governance; such as removal of violence, addition of certain advertising, deliverance to a specific address or addresses, assignment of individual values i.e. bit streams/budgets or video ratings or authorizations, etc. These techniques as applied to the structure and transmission of video provide a tremendous amount of flexibility in how we manage the video. This is in contrast and opposed to having to add or increase spectrum allocations to accommodate more video streams as a result of asynchronous interactive selections on the part of the viewers.

Technology created by the invention allows viewers to, instantly and without delay, view prerecorded, distributed and stored video programs, as well as live-broadcasts. Viewing will appear as if it had been broadcast in real-time as opposed to the delays associated with storing and downloading video programs. Fundamentally, these techniques and processes resolve the bandwidth, video server processing power and streaming capacity issues, associated with offering users a large array of video programming selections, by sectoring video programs into segments and distributing the segments throughout various components of the distribution network, then timing the dispersal of the segments on an as needed basis.

Segmenting and decentralizing the data distribution by placing video data in network components at close proximity to the end users reverses the bandwidth and video streaming capacity paradigm. Bandwidth requirements are minimized because delivery of selected programming is no longer in direct proportion to the number of channels being offered. With technology of the invention, it is not necessary to simultaneously stream all selections to offer users a plurality of choices. Instead each viewer can select and order when and what they want to view. Wireline or wireless means that are provided by any existing or future technology (such as fiber cable, co-axial cable, telephone wire, power line cable, terrestrial or satellite) transmit formatted video segments.

Conceptually, the technology's architecture provides cable TV, wireline, terrestrial wireless or satellite Multi-Channel Video Program Distributors (MVPD) with a system and/or method of sectoring video programs into data segments for distributing video on a microcasting basis. Interactive TV, video on demand (addressing entertainment, educational and/or other microcasting needs) and pay-per-view of prerecorded video transmission are its rudimentary applications. A further application of the technology is its ability to match and assign user demographics and user preferences with advertisements of similar characteristics, then insert ad spots that reflect these characteristics at an assigned location into the video data. The invention is a decentralized distributed video and video segmentation technology in contrast with the more obvious and common centralized video streaming technologies. FIG. 5(a) shows the formatting process. Digital video programs are divided into video scenes (VS) of variable length. These video scenes are further divided into video segments of fixed or variable length. A video segment (VSG) header and VS attributes (such as flags, tags, marks, compression type, and content rating etc) are attached to each video segment facilitating the storage and transmission of the formatted segments.

Attributes are used to transform a video from a singular data file, which can only be stored and transmitted as a singular video stream or sequential bursts, to a collection or plurality of independent data segments that can be randomly stored, transmitted and acted upon as separate data files. The attributes comprise the instructions and associated tests for each video segment. Video segments can be transmitted in a plurality of transmission schemes, opened and viewed independently of other segments that are part of the video or can be given other instruction that could effect the timing, coordination or the ultimate content viewed or how the content is viewed. The number and types of attributes contained within a video segment will be dependent on the number and/or types of instructions necessary for the video segment to carry out its mission.

These attributes are classified by functionality. As illustrated in FIG. 5(a), a video segment has a header, specific attributes and video content. In the illustration, VSatr is the acronym used to depict the attributes such as VSatr 1, 2 through z. Any number of flags, tags, marks, and codes will designate instructional items such as segment transmission instructions, authorized movie ratings instructions, coordination of viewing sequence, overwrite instructions, web linking instructions, transmission sequence instructions, ad selection and insertion instructions, and branching instructions, etc. Anyone knowledgeable in the field can create any number of or types of instructions that can be used to expand the base list of attributes within the teachings of the present Invention. Therefore the teachings contemplate that as the technology is disclosed and used, more attribute types and classes will be created to meet the dynamic nature of the video industry. Not every segment will contain every type of attribute but will carry the basic functional categories of attributes. These functional categories are critical contingency microcasting codes placed into each segment. Formatting codes, transmission codes, communications codes, interactive element codes, web link codes, storage location codes and viewing sequencing codes are examples of basic functional categories. Flags tags, and other marks are used to identify specific designates such as users, locations, links and server and client activities within the principal codes to achieve the desired microcasting of the video segment.

FIG. 5(b) illustrates one possible attribute structure. Individuals familiar with the art can create any number of structural schemes of attributes. In this figure capital letters are used to illustrate codes, digits are used to illustrate flags, small letters are used to illustrate tags, and the word user and a number are marks used to identify the household user. Codes designate how the segments relate to specific functions. For example code A designates the off function as it relates to the movie ratings system in relationship to the user. If a video segment is flagged with 001 and the user as designated by the mark is tagged with aaa then code A will turn off or not show the video segment for that particular user. In this case, User 1 is tagged aaa thus restricted from viewing those movie segments flagged 001. For discussion purposes only, Code B designates bit rates as related to the conducting of certain tests, which are designated by flags. The results of the tests are tagged and reported providing the instructions of what bit rate is best used by the user's client to view the video segment. In the case of User 2 on the chart in FIG. 5(b), the test flagged 002 and the results tagged as bbb indicate that the viewing speed of the segment will be determined by the formula in code B. If: the value of a is greater than x but equal to 1, which is less than y, which is 3.2 (a>x=1<y 3.2) then the viewing transmission speed at the client will reflect the appropriate value somewhere between 1 Mbps and 3.2 Mbps. Although not addressed in this discussion the values for a, x, and y or any other pertinent designate are dependent of such factors as available bandwidth, number of users on the system, server processing speed and any number of other variables therefore a specific example is not illustrated. Those individuals proficient in the art can establish values and formulas specific to their transmission network.

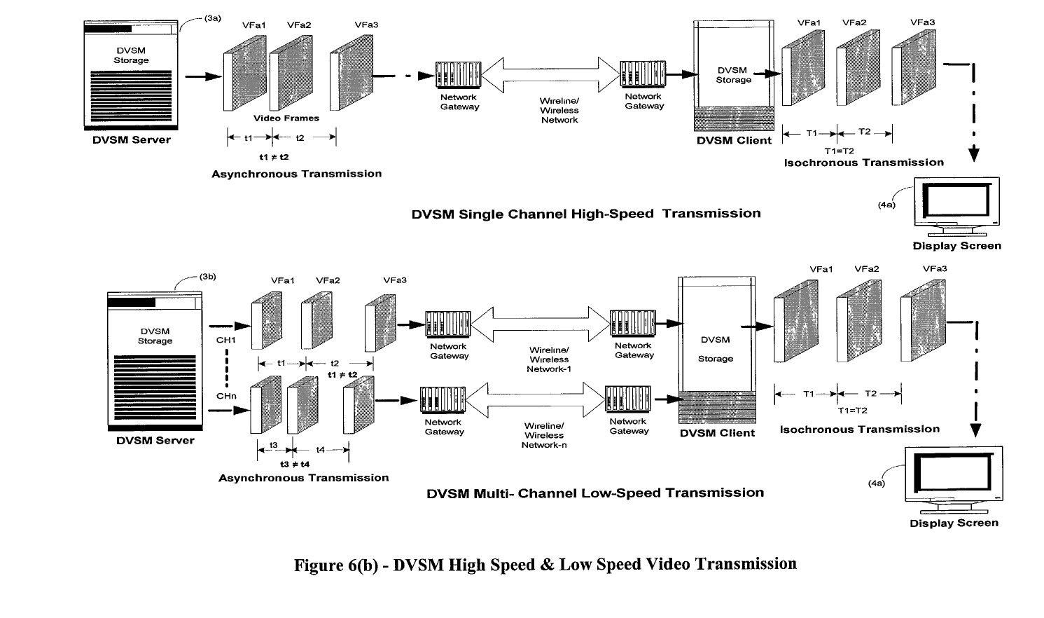

Transmission of DVSM data segments includes both asynchronous and isochronous techniques to move video data through any type of network in use. FIGS. 6(a) illustrates a comparison between the real-time isochronous transmissions of streaming video technologies, and the isochronous transmission of video bursting technology.

Video Streaming and video bursting technologies are primarily designed for broadcasting of live events, a fundamental requirement of these technologies is that the net-effective data transfer rate from the server to the client must equal the real-time data rate. To meet this requirement, the streaming video server (1a) isochronously transmits video frames VFi 1, VFi 2, VFi 3, VFi (z-1) through VFi z within fixed and constant time intervals, t1, t2 through tz, to the network gateway. The gateway at the server transfers video frames to the network gateway at the client site. This transfer method depends on the network topology, but must be conducted in real-time mode. The video frames are temporarily stored in cache memory of video client (2a)/(2b). These video frames are then isochronously displayed on a PC Monitor or a TV Screen in real-time.

Video bursting technology differs from the streaming technology only at the server end. Instead of sending a continuous stream of video frames, the bursting server (1b) sends bursts of frames to the gateway in real-time mode. The primary advantage of bursting over streaming is that it facilitates transferring of other data in-between the video-bursts on a shared network.

DVSM technology is primarily designed for interactive VOD applications. Since the video program is pre-recorded and stored, DVSM does not impose the limitation of “net effective data transfer rate equal to real-time” on the system and the network. Instead, DVSM formatted video data is transferred at net-effective speeds faster than the real-time, and stored at the DVSM client. The client then sends isochronous video frames to the display in real-time mode.

As illustrated in FIG. 6(b), there are two different modes of data transfer from the DVSM server to the gateway. Single channel high-speed (faster than real-time) mode is suitable for broadband networks (such as fiber-optic, coaxial cable), while the low-speed multi-channel mode is suitable for low bandwidth networks (such as twisted-pair(s) copper wire). However, the total sum of low speed data channels must be higher than the real-time video data transfer rate. Anyone competent in the art can find application in a plurality of channel configurations for video frames transmission as contemplated by the invention. These two are preferred configurations most applicable to broadband and narrowband transmission.

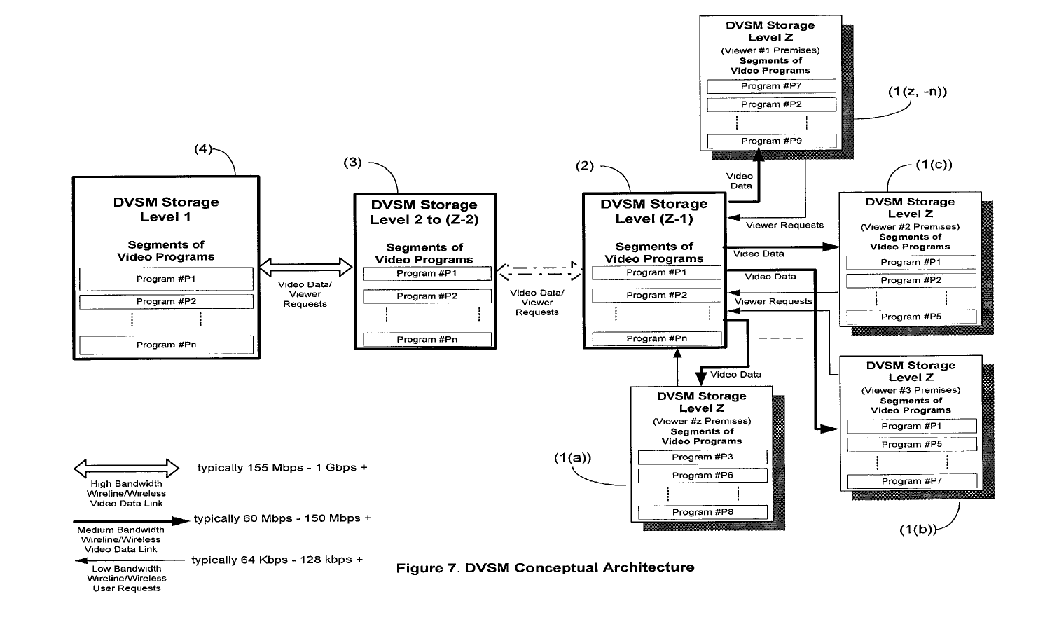

Beginning at Level 1 through Level (Z-1), (see FIG. 7) server (3a and 3b) asynchronously transmits video frames VFa 1, VFa 2, VFa 3, VFa (z-1) through VFa z to client (4a and 4b) at the CPE with variable time intervals, T1, T2 through Tz. Video frames received at the client (4) are either stored for latter transmission or immediately isochronously transmitted for viewing as video frames VFi 1, VFi (z-1) through VFi z to TV/Monitor (5). Storage in the client (4) enables the user to control the viewing of the video.

II. System Architecture

With reference to FIG. 7, a functional block diagram of the conceptual architecture for a system of a plurality of storage levels and the bidirectional transmission of video data segments from level Z through level 1. Architecturally, the Invention provides for a plurality of levels for video data storage within network components as conceptually illustrated in FIG. 7. DVSM Storage Level 1 (4), DVSM Storage Level 2 to (Z-2) (3), and DVSM Storage Level (Z-1) (2) maintain video segments for a plurality of programs, i.e., Program #1, Program #2 through Program #n. DVSM technology is used to manage, maintain and control video data segments at all DVSM storage levels within their respective network components. DVSM Storage Level(s) Z (1(a)), (1(b)), (1(c)) and (1(z, -n)) are located at the individual customer's CPE and maintain only video segments that are requested by the user, at the time the user makes the request and subsequently as needed for uninterrupted viewing. Video data and user data flows bi-directionally via wireline or wireless links between Level 1 (4) to Level 2 to (Z-2) (3) to Level (Z-1) (2) and finally to Level(s) Z (1(a)), (1(b)), (1(c)) and (1(z, -n)). Video data flows from Level 1 4 downstream through Level 2 to (z-2) 3 and Level (Z-1) 2 to the CPE. Viewer requests data flow upstream to Level (Z-1) (2), then to Level 2 to (Z-2) (3) and finally if necessary to Level 1 (4). In an ascending order, beginning at Level Z (1(a)) through (1 (z, -n)), each subsequent level of storage has a greater plurality of storage capacity than its complimentary or previous level.

Wireline or wireless links between levels are asynchronous. Downstream, typical video data link requirement(s) for Level 1 (4), Level 2 to (Z-2) (3), and Level (Z-1) (2) are between 155 Mbps to 1 Gbps of High Bandwidth. Downstream, typical video data link requirement(s) between Level (Z-1) (2) and Level Z (1(a)), (1(b)), (1(c)) and (1(z -n)) are between 60 Mbps to 150 Mbps of medium bandwidth. Typical wireline or wireless upstream data link requirement(s) for all levels are between 64 Kbps to 128 Kbps.

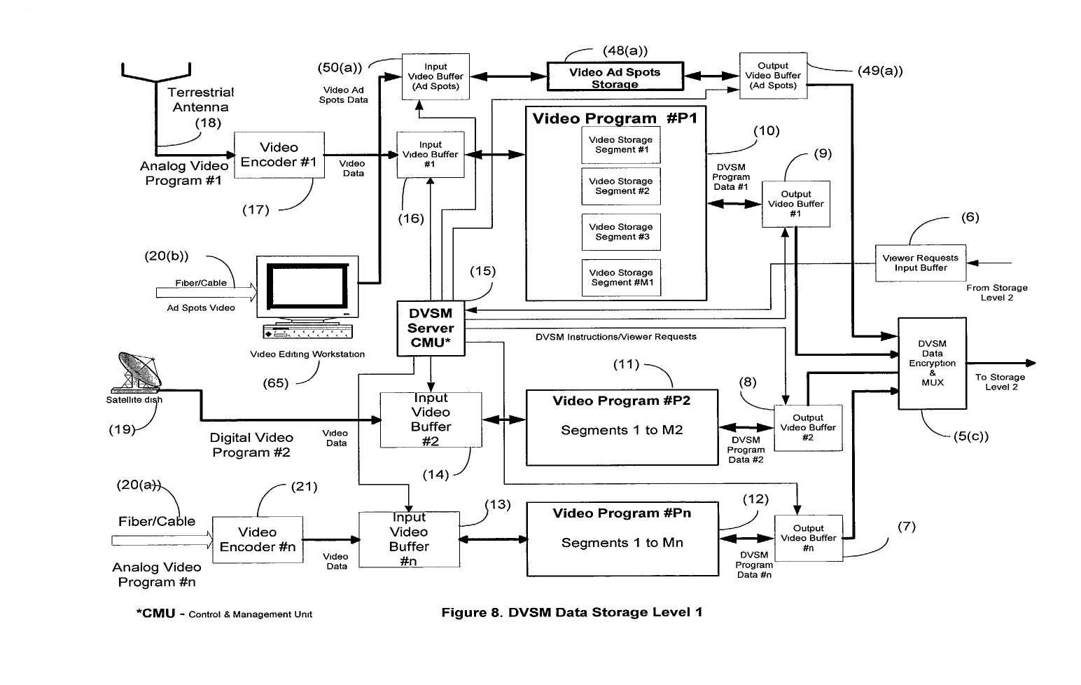

With reference to FIG. 8, functional block diagrams of the DVSM data storage level 1 and its system are shown. Wireless Terrestrial Antenna (18), Satellite Dish (19) and wireline Fiber/Cable (20(a)) and (20(b)) receive analog and/or digital video signals. Video Encoder #1 (17) through Video Encoder #n (21) process Analog Video Program signals (#1 through #n) and convert them into digitized video data. Digital Video Program #2 signals are received into Input Video Buffer #2 (14). Video Editing Workstation (65) receives Ad Spot Video transmitted through (20(b)). Input Video Buffers #1 (16), Input Video Buffer #2 (14) through Input Video Buffer #n (13) receive digital data from Satellite Dish (19) and Video Encoders #1 (17) through #n (21). Input Video Buffer (Ad Spots) (50(a)) receives video data from Video Editing Workstation (65). Ad Spots are processed at workstation (65), having been assigned priorities, restrictions and classifications code(s).

“DVSM Server CMU” (15) provides the Input Video Buffers #1 (16), #2 (14) through #n (13) and Input Video Buffer (Ad Spots) (50(a)) processing instructions for video data and ad spots data received by all Video Input Buffers. “DVSM Server CMU” (15) is the data manager, which determines data segment lengths, assigns random storage locations (addresses), flags, tags and designations to video and ad spots data. Input video buffers process the video and ad spots by sectoring the video and video clips into segments. Then the buffers place video data segments into a plurality of random video storage or Video Ad Spots Storage (48(a)) locations as Video Program #P1 (10), Video Program #2 (11), through Video Program #Pn (12). Each segment is assigned specific storage codes in preparation for the microcasting process.

Viewer requests are received from Storage Level (2) by the Viewer Request Input Buffer (6), which sends the requests to “DVSM Server CMU” (15). The “DVSM Server CMU” (15) provides processing instructions to the appropriate input video buffer. Selected video segments from Video Program #1 (10) (i.e., Video Storage Segment #1 through #M1), Video Program #2 (11) and/or through Video Program #n (12) are processed as DVSM Program Data #1, DVSM Program Data #2 and/or through DVSM Program Data #n. Subsequently data is sent to the appropriate Output Video Buffer #1 (9), Output Video Buffer #2 (8), through Output Video Buffer #n (7). Video ad spots segments are sent to Output Video Buffer (49(a)), where instructions are received from “DVSM Server CMU” (15) and the segments are processed. Program and ad spot data is processed at the appropriate output video buffer and sent to the DVSM Data Encryption and MUX (5(c)) for transmission to Storage Level 2 to (Z-2).

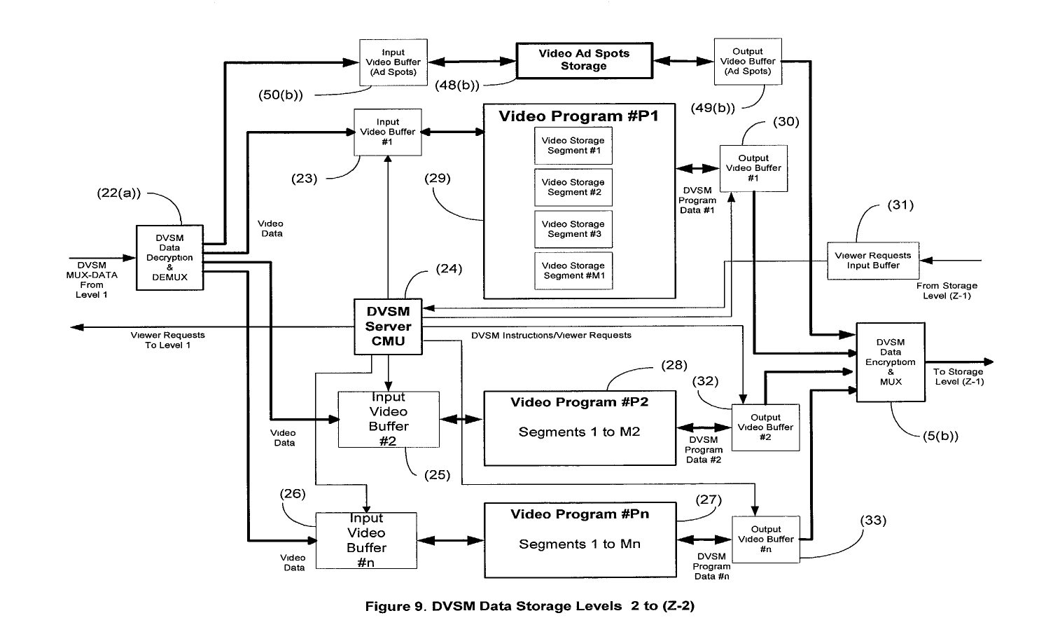

With reference to FIG. 9, functional block diagrams of the DVSM data storage levels 2 to (Z-2) and their systems. DVSM Data Decryption and DEMUX (22(a)) at DVSM Storage Level 2 to (Z-2) receives selected DVSM Program Data #P1, #P2 through #Pn and ad spots segments from DVSM Storage Level (1). Data segments are transmitted to the appropriate input buffer, i.e., Input Video Buffer #1 (23), Input Video Buffer #2 (25), Video Buffer #n (26) and/or Input Video Buffer (Ad Spots) (50(b)). DVSM Server CMU (24) sends control instructions to input video buffers regarding data received from Level 1 and data resident in Level 2 to (Z-2). Data segments are stored within Video Program #P1 (29) as segments #1, #2, #3 through #M1, Video Program #P2 (28) as segments #1 to M2 and Video Program #Pn (27) as segments 1 to Mn or as ad spots segments. As in DVSM Storage Level 1, the DVSM Server CMU (24) at DVSM Storage Level 2 to (Z-2) is the data manager who determines data segment lengths, assigns random storage locations (addresses), flags, tags and designations. DVSM Server CMU (24) receives viewer requests from Viewer Request Input Buffer (31) and processes those requests. All viewer requests associated with video segments stored at DVSM Storage Level 1 are transmitted to DVSM Storage Level 1. Viewer requests associated with video segments stored at DVSM Storage Level 2 to (Z-2) are processed by input video buffer(s) (23), (25), (26) and/or (50(b)).

Selected video segments received from DVSM Storage Level 1, or resident at DVSM Storage Level 2 to (Z-2), are transmitted as DVSM Program Data #1, #2 and #n or ad spots to the appropriate output video buffer. These segments are designated as Video Ad Spots (48(b)), Video Program #P1 29, Video Program #P2 28 and Video Program #Pn (27). Data processed by Output Video Buffer (Ad Spots) (49(b)), Output Video Buffer #1 30, Output Video Buffer #2 (32) and/or Output Video Buffer #n (33) is transmitted to DVSM Data Encryption and MUX (5(b)). The DVSM Data Encryption and MUX (5(b)) transmits the DVSM Program Data to Storage Level (Z-1).

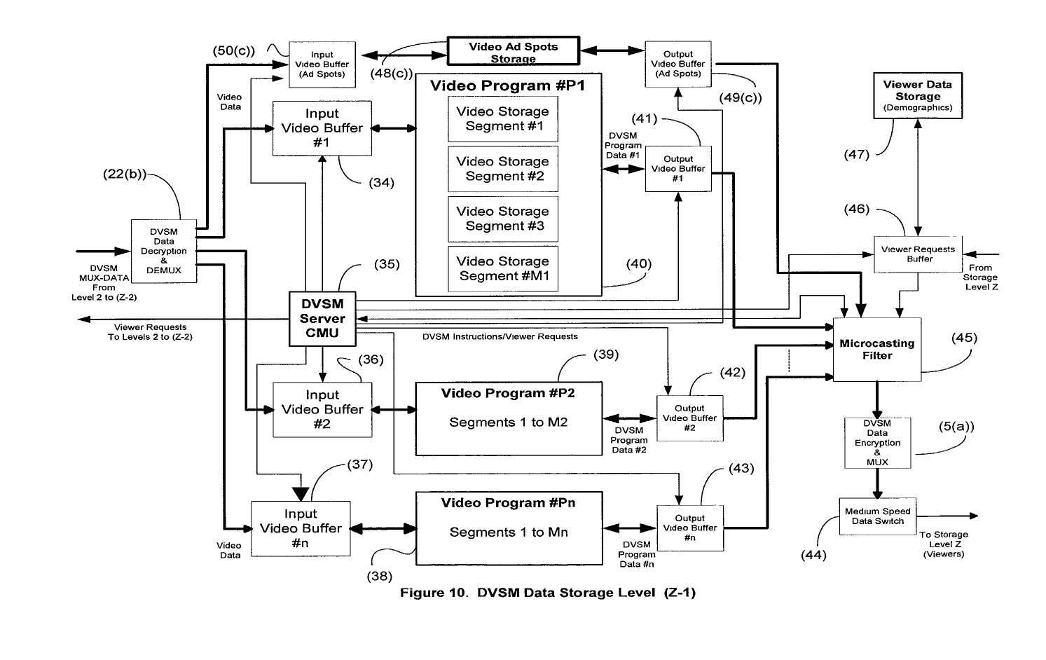

With reference to FIG. 10, functional block diagrams of the DVSM data storage level (Z-1) and its systems. The DVSM Data Decryption and DEMUX (22(b)), as illustrated, receives DVSM Encrypted and multiplexed data from the previous Level 2 to (Z-2) at DVSM Level (Z-1). Input Video Buffer for Ad Spots (50(c)), Input Video Buffer #1 34, Input Video Buffer #2 (36) and/or Input Video Buffer #n (37) receive data from the DVSM Data Decryption and DEMUX (22(b)). Commercial ad spots data received at the Input Buffer for Ad Spots (50(c)) is transmitted to Ad Spots Storage (48(c)). Control instructions, from the “DVSM Server CMU” (35), are sent to each input video buffer (37), (36), (34), and (50(c)). Viewer requests and Viewer Demographics are received by the Microcasting Filter (45), through the Viewer Request Input Buffer (46), and transmitted to the DVSM Server CMU (35). Data from Level 2 to (Z-2), along with any resident data stored as Video Program #P1 40, Video Program #P2 (39) and/or Video Program #Pn (38), is processed at the appropriate data buffers and Microcasting filter, based on viewer requests and instructions from the DVSM Server CMU (35). Program data segments are transmitted to the appropriate Output Video Buffer #1 (41), #2 (42) and/or #n (43) as well as Output Video Buffer Ad Spots (49(c)). Processed program and ad spots segments are sent to the Microcasting Filter (45). DVSM program data is combined with its appropriate commercial advertising segments as requested by the user, or determined by the viewer demographic profile as provided by the user. The combined Data segments are transmitted to the DVSM Data Encryption and MUX (5(a)). Restructured video data segments, complete with all new overheads, are sent to the Medium Speed Data Switch (44) for microcasting to viewers at Storage Level Z.

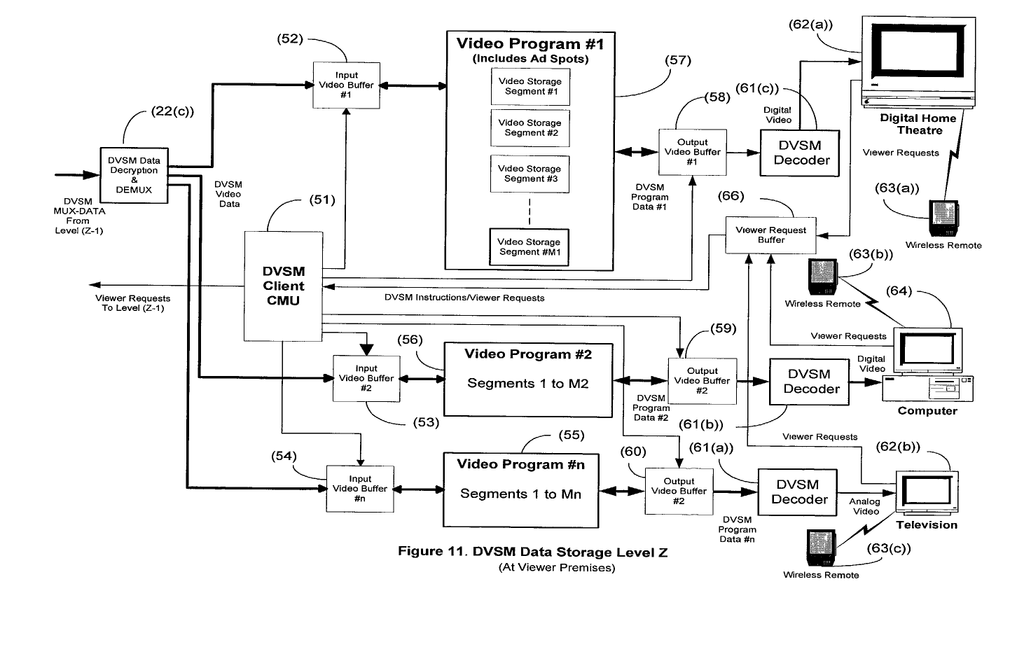

With reference to FIG. 11, functional block diagrams of the DVSM data storage level Z and its systems. DVSM Data Storage Level Z is located at the customer premise equipment (CPE). FIG. 11 DVSM Storage Level Z illustrates the use of the invention's techniques and processes to deliver microcast video data to a plurality of TV set and/or PC equipment. DVSM Data Decryption and DEMUX (22(c)) receives multiplexed Data from Level (Z-1), decrypts and de-multiplexes it, then transmits it to Input Video Buffer(s) #1 (52), #2 (53) and #n (54).

On screen video data can be requested by a plurality of user equipment. As illustrated, users can use standard Television (62(b)) equipment, Digital Home Theater (62(a)) equipment and/or Computer (64) with a typical monitor. Wireless Remote(s) (63(a)), (63(b)) and (63(c)) represent a plurality of typical interactive communications equipment and their appropriate network interface equipment. Wireless or wireline keyboards and/or common PC mouse equipment can also be used. Using this type of equipment, users transmit their requests to Viewer Request Buffer (66). These requests are received by DVSM Client CMU (51), which sends instructions to Input Video Buffer(s) (52), (53) and (54) as well as Output Video Buffer(s) (58), (59) and (60) and/or forwards instructions and requests to Level (Z-1). Output Video Buffer(s) (58), (59), and/or (60) retrieve requested and appropriate video data segments from plurality of program storage locations, Video Program #1 (57), Video Program #2 (56) and/or Video Program #n (55). Selected data is then sent to a plurality of DVSM Decoder(s) (61(a)), (61(b)), and/or (61(c)). The decoders process the video data and send it for viewing to a plurality of viewing equipment, i.e., Digital Home Theater (62(a)), Computer (64) and/or Television (62(b)).

II. System Algorithms and Operation

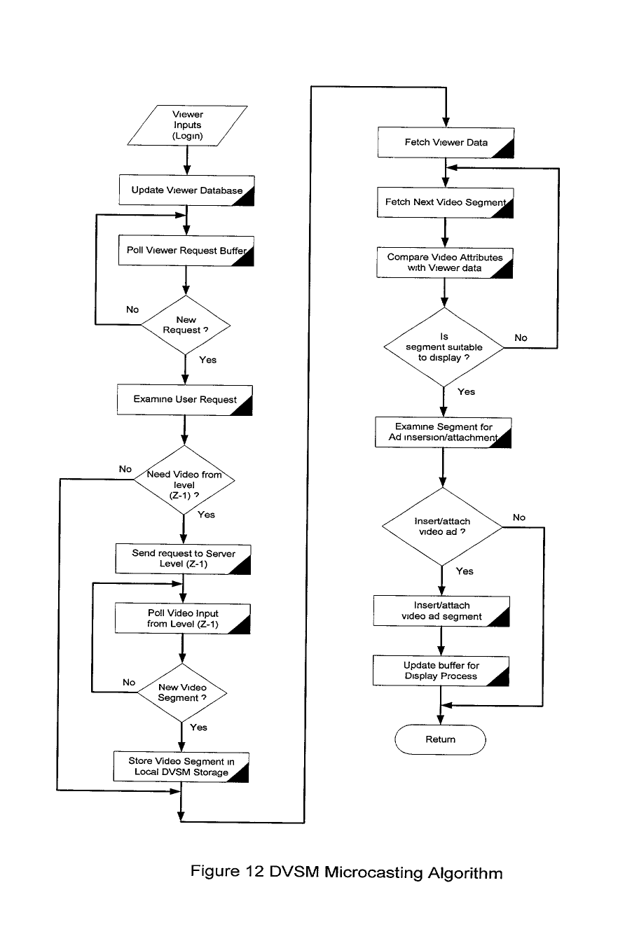

A more detailed description of the algorithms and operation the system and method of the present invention are provided with reference to FIGS. 12-20.

Referring to FIG. 12, DVSM Microcasting Algorithm, the DVSM Client software at the viewer's CPE primarily uses the microcasting algorithm. The basic microcasting algorithm illustrated in FIG. 12, which only shows the fundamental processes necessary to accomplish the basic microcasting functions. The actual implementation of the algorithm may vary depending on the type of application software used, and the details of implemented functions.

The algorithm starts with viewer inputs as he logs-on to the client software. After his login entries are completed, the user database, specifically related to his records, is updated. If the viewer makes a new request, the request is examined to determine if the system can service his request using the local database (level Z) at CPE. If not, a request is sent to the next level Z-1. After the new video segment is received from level Z-1, it is stored in the local database. The next process fetches the viewer data and the new video segment to be displayed on viewer screen. It compares the attributes of the new segment with the viewer profile data and determines whether the segment is suitable to display for the individual viewer making the request. If the segment is not suitable, it fetches the next sequential segment and repeats the same process. If it is suitable, the next process continues which examines the video segment for advertisement-clip insertion, or attaching the clip to be displayed as a separate window without breaking the continuity of the video program. After inserting/attaching the ad-clip, the appropriate buffer is updated and display process is activated to display the sequence of program segments and advertisement segments.

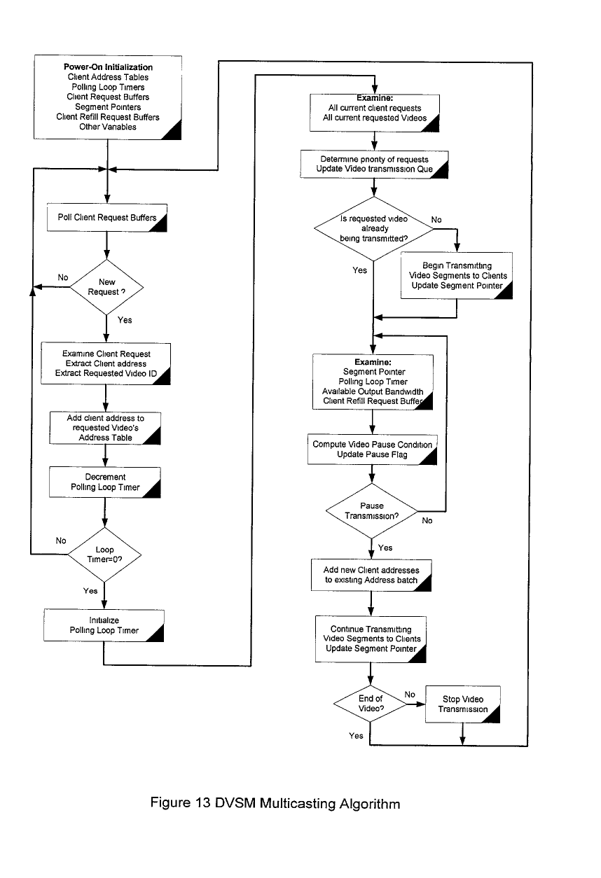

Referring to FIG. 13, DVSM Multicasting Algorithm, a system of programming software that illustrates the basic multicasting algorithm, which only shows the fundamental processes necessary to accomplish the multicasting functions. The actual implementation of the algorithm may vary depending on the type of application software used, and the details of implemented functions.

The DVSM Server software located at levels (Z-1) primarily uses the multicasting algorithm to level (1). The algorithm starts with initializing all the variables as the system power is turned ON. After initialization, the process enters into a polling loop to read client (viewer) request buffers. The time interval of the polling loop is programmable and can be a fixed interval, or variable interval. During each cycle of the polling loop timer, the polling process examines every client request and extracts requesting the client's network address and the ID of the requested video. Each video has a table associated with it, which holds the addresses of clients requesting that video to view. When a new client request is received, the table is updated by adding his network address to the table. At the end of polling interval, the loop counter is re-initialized for the next polling cycle. The next process examines total number of client requests and total number of requested video programs. The priority of each request is determined based on the present status of relevant system variables, and the Video Transmission Queue is updated. At the next decision-point, the transmission status of the current video program is checked. If the video transmission is not in progress, the transmission process is activated. If the requested video is already being transmitted, the next process begins examining the status of relevant variables and buffers to compute Pause Condition for the current video being transmitted. If it is not appropriate to pause, the transmission continues till the Pause Flag is set. At that point, the new client addresses are added to existing address batch, the Pause Flag is reset, and the paused video transmission starts again. The transmission of sequential segments continues till the end of video program. The polling loop process continues the next cycle and begins examining new client requests.

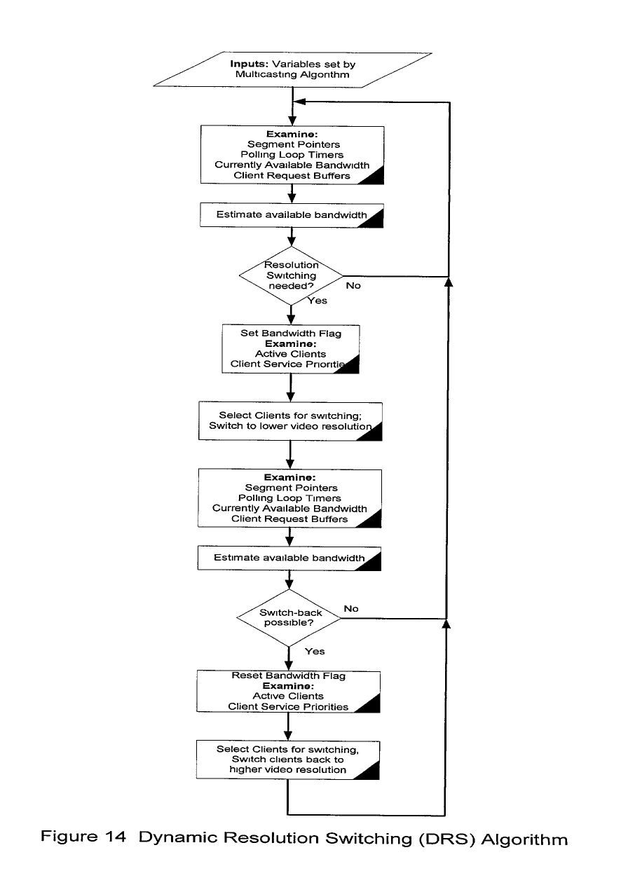

Referring to FIG. 14, Dynamic Resolution Switching Algorithm, is the technique used by the server software to ensure uninterrupted video transmissions to all the users during a time interval when the available bandwidth is not sufficient to meet peak demand. FIG. 14 illustrates the basic algorithm, which only shows the fundamental processes necessary to accomplish the resolution switching functions. The actual implementation of the algorithm may vary depending on the type of application software used, and the details of implemented functions.

This algorithm uses inputs from variables and buffers dynamically updated by the multicasting algorithm. The 1^{st} process examines the status of these variables and buffers, and estimates available bandwidth to transmit next batch of video segments. If the estimated bandwidth is not enough, the Bandwidth flag is set, which initiates the next process. The addresses of clients with active requests are extracted, and client service priorities are examined. The clients with lowest priority are selected and grouped together. At the end of current segment transmission, the selected clients are switched over for lower resolution transmission. The process is repeated to meet the demand of all pending client requests.

After reaching a balanced state of video transmission for all the active clients, the next process starts examining relevant variables and buffers, and estimates available bandwidth to determine if a switchback to higher resolution is possible. If so, the bandwidth flag is reset, and the next process begins to examine the active clients and their service priorities. The highest priority clients are switched back to higher resolution transmission, followed by the next batch of clients till a balanced condition is reached. These processes continue working in synchronization with the polling loop timer of the multicasting algorithm.

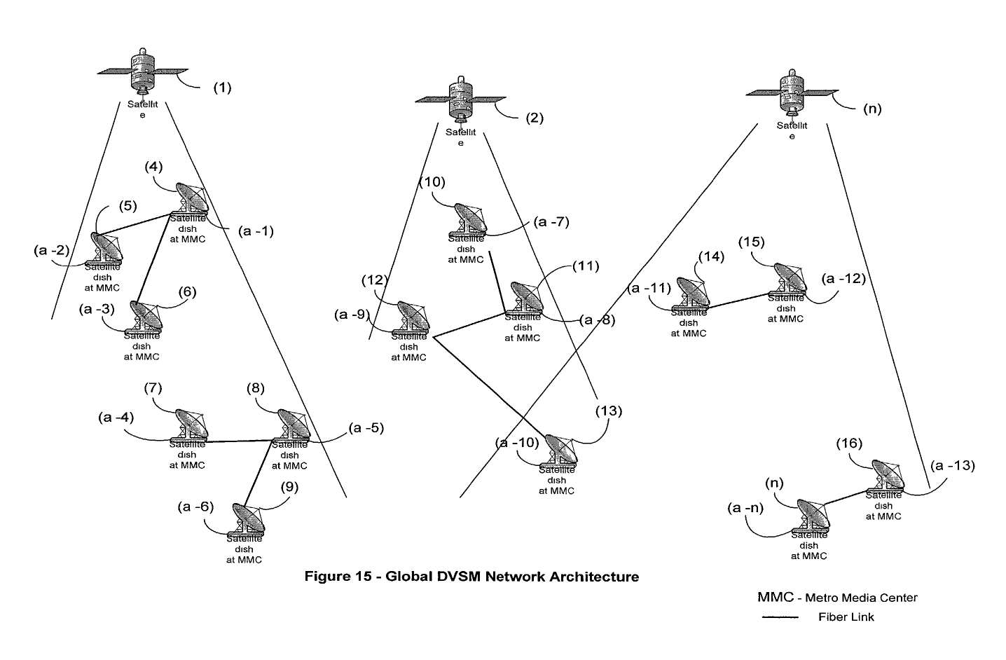

FIG. 15 is a functional block diagram and illustration of the global architecture as the invention relates to a system of linked satellite transmitters and receivers used to provide access to and from program vendors, customers, producers and any other entity necessary to sending or receiving video programs. Satellites (1) through (n) send and receive video data wirelessly to satellite dishes (14) through (n) and satellite dishes (14) through (n) attached to a plurality of MMC (a-1) through (a-n) receive and send video data wirelessly to satellites. Fiber links between MMC (a-1) through (a-n) provide communications between each MMC. Links to and from program vendors, customers, producers and any other entity are illustrated as satellite links but are not restricted to satellite links any form of communications links can be used.

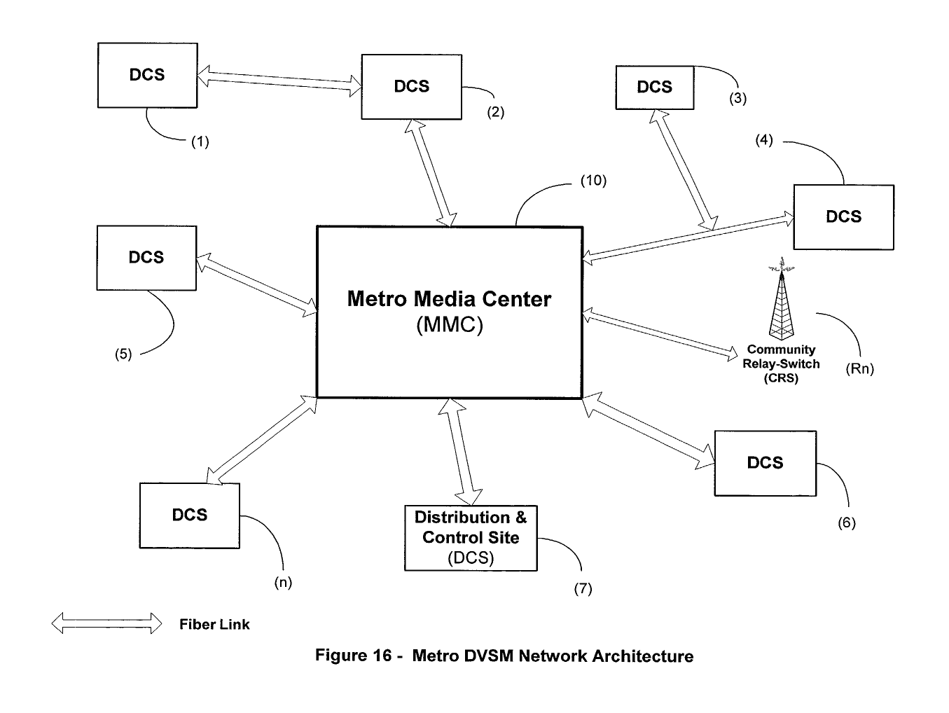

FIG. 16 is a functional block diagram and illustration of the local metro media center (MMC) architecture as the invention relates to a system or communications network of wireline fiber links associated with a plurality of distribution and control sites (DCS). These links are the bi-directional paths used to transmit video data to and from the MMC and to and from a plurality of DCS sites. MMC (10) is connected to a plurality of DCS (1) through (n) and a plurality of Community Relay Stations (n) by wireline or wireless means. As illustrated DCS (1) is connected to DCS (2) and any number of DCS sites can be linked directly to each other and any number of Community Relay Stations (n).

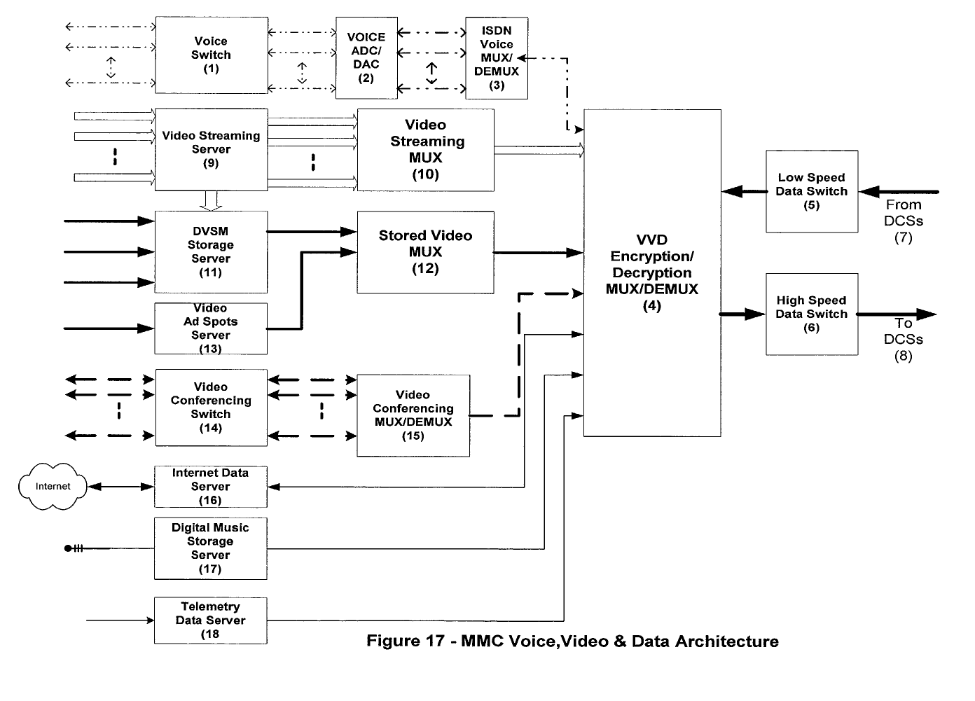

FIG. 17 is a flow diagram representing the bi-directional flow of data through a metro media center system for voice, video and data transmission according to the present invention. In this illustration the voice, video, and data architecture contemplates the MMC is designed for multi data transmission. Voice transmission to and from an external voice switch (1), such as those found in a public switch telephone network, are received and sent by the voice analog-to-digital converter/digital-to-analog converter ADC/DAC (2). A bi-directional link transmitting voice signals is established between the ADC/DAC (2) and the ISDN Voice MUX/DEMUX (3) and the ISDN Voice MUX/DEMUX (3) receives or sends voice signals to the (voice, video and data) VVD Encryption/Decryption MUX/DEMUX (4). High Speed data switch (5) transmits signals to a plurality of DCS sites (7) and High Speed data switch (6) receives signals from a plurality of DCS sites (8). Streaming video data is received video streaming server (9) and processed then transmitted to the Video Streaming MUX (10) or the DVSM data storage server (11) for processing and storage. Live streaming video received by the Video Streaming MUX (10) is processed and transmitted to the VVD Encryption/Decryption MUX/DEMUX (4) for processing then transmitted to the High Speed data switch (5) for transmission to DCS sites (7).

When requested, programs stored in DVSM data storage server (11) are transmitted to the Stored video MUX (12) and processed then are transmitted to the VVD Encryption/Decryption MUX/DEMUX (4). Processed stored video is then transmitted to the High-Speed data switch (5) for transmission to DCS sites (7).

Video ad spots received in the Video Ad Spots Server (13) are transmitted to the Stored video MUX (12) when requested. Subsequently the signals are inserted into the designated video program content and transmitted to the VVD Encryption/Decryption MUX/DEMUX (4) for transmission to High-Speed data switch (5) for transmission to DCS sites (7).

For purposes of video conferencing, video conferencing signals received at the Video Conferencing Switch (14) are processed and transmitted to the MMC Video Conferencing MUX/DEMUX (15). Subsequently the video conferencing signals are transmitted to the VVD Encryption/Decryption MUX/DEMUX (4) for transmission to High-Speed data switch (5) for transmission to DCS sites (7).

Internet data signals are received and transmitted to and from the ISP Data Server (16) then processed and bi-directionally transmitted to the VVD Encryption/Decryption MUX/DEMUX (4) for bi-directional transmission to and from the High-Speed data switch (5) for transmission to and from DCS sites (7).

Digital Music Storage Server (17) receives audio signals for processing and storage or for transmitting user request data to and from the VVD Encryption/Decryption MUX/DEMUX (4) for bi-directional transmission to and from the High-Speed data switch (5) for transmission to and from DCS sites (7) when requested.

Telemetry data is received and transmitted to and from the Telemetry Data Sever (18) to and from the data source and the VVD Encryption/Decryption MUX/DEMUX (4) for bi-directional transmission to and from the High-Speed data switch (5) for transmission to and from DCS sites (7) when requested. Telemetry data consist of data collected for such things as gas, electric and water meter reading devices, wireless hand-held Internet devices or any such device used in field activities.

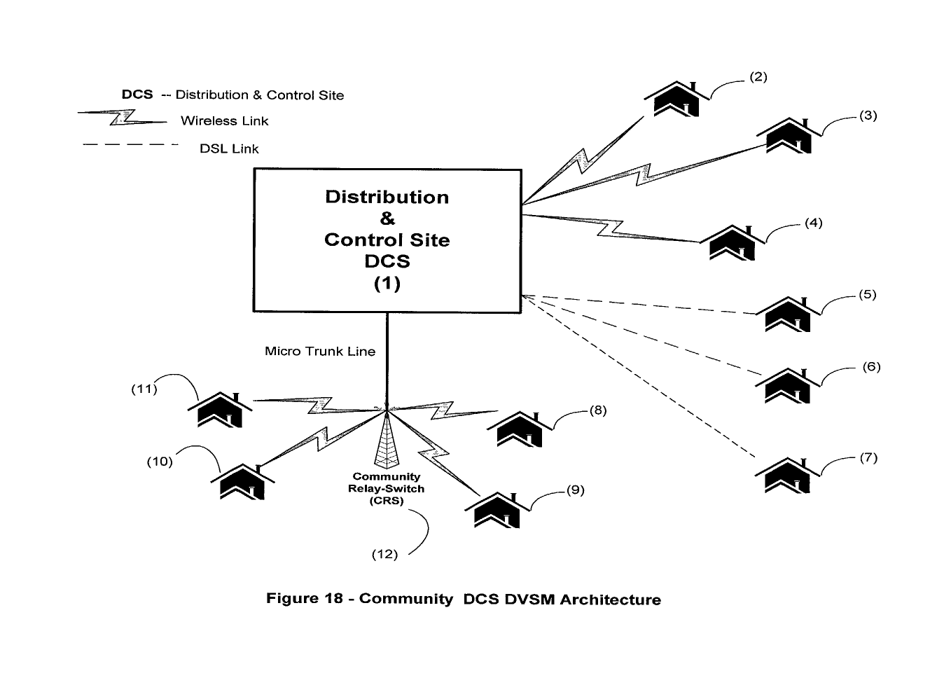

FIG. 18 is a block diagram representing a plurality of connections between a distribution and control site and a plurality of homes according to the present invention. This architecture provides for the transmission of video data signals to be conducted using wireless or wireline means and for accommodating a plurality of community relay switches (12) to be linked by wireline or wireless means to user homes (8), (9), (10) and (11). The Distribution and Control Site (1) is wirelessly linked to homes (2), (3) and (4) and linked by wireline means to homes (5), (6) and (7). These wireline links can be packet-switched lines; cable TV lines, micro trunk lines or circuit switched lines.

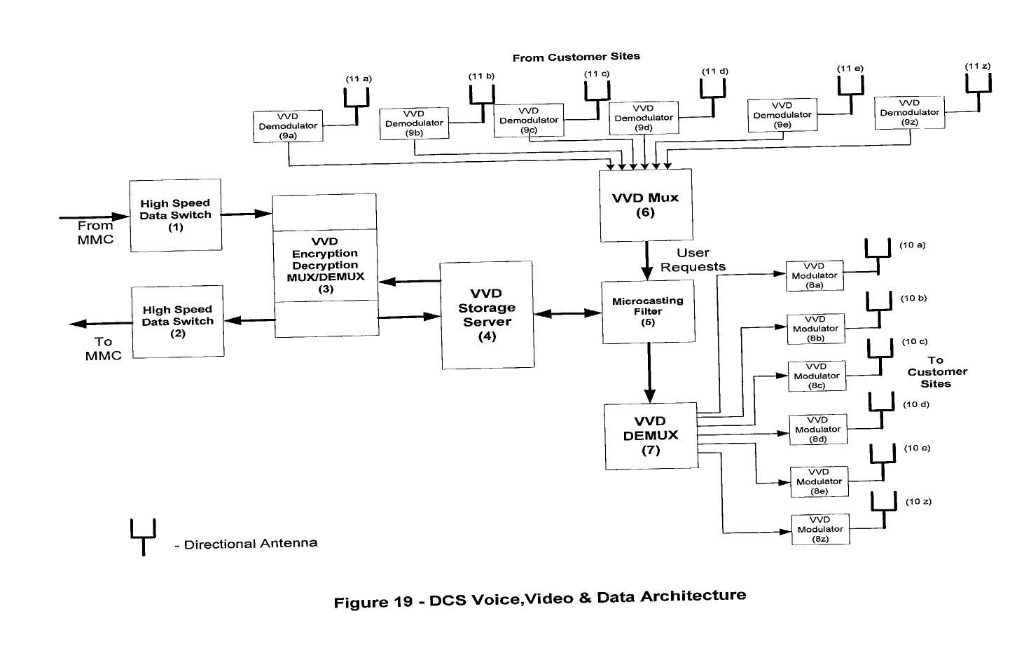

FIG. 19 is a flow diagram representing the bi-directional flow of data through the distribution and control site architecture of the system for voice, video and data communications. According to the present trends, voice, video and data networks will be common in anticipation of this potentiality the invention accommodated for such an eventuality within the network.

Voice, video or data transmissions are received by the High-Speed Data Switch (1) processed and transmitted to and from the VVD Encryption/Decryption MUX/DEMUX (3) for processing. Transmissions received from the High-Speed Data Switch (1) are transmitted to the VVD Storage Server (4) processed and transmitted to the Microcasting Filter (5) then processed and transmitted to the VVD DEMUX (7). Signals processed at the VVD DEMUX (7) are transmitted to a plurality of VVD Modulators (8a) through (8z) then wirelessly transmitted to customer site to be received by directional antennas (10a) through (10z).

Antennas (11a) through (11z) wirelessly transmit user voice, video and data request or signals to VVD Demodulators (9a) through (9z) who process the signals and transmit the voice, video and data request to VVD MUX (6). After processing the data VVD MUX (6) transmits the data to Microcasting Filter (5) who processes the data and transmits it to VVD Storage Server (4). At the VVD Storage Server (4) data is prepared for storage and stored or transmitted to the VVD Encryption/Decryption MUX/DEMUX (3) who processes the data and transmits it to the High-Speed Data Switch (2) from which the data is transmitted to the MMC.

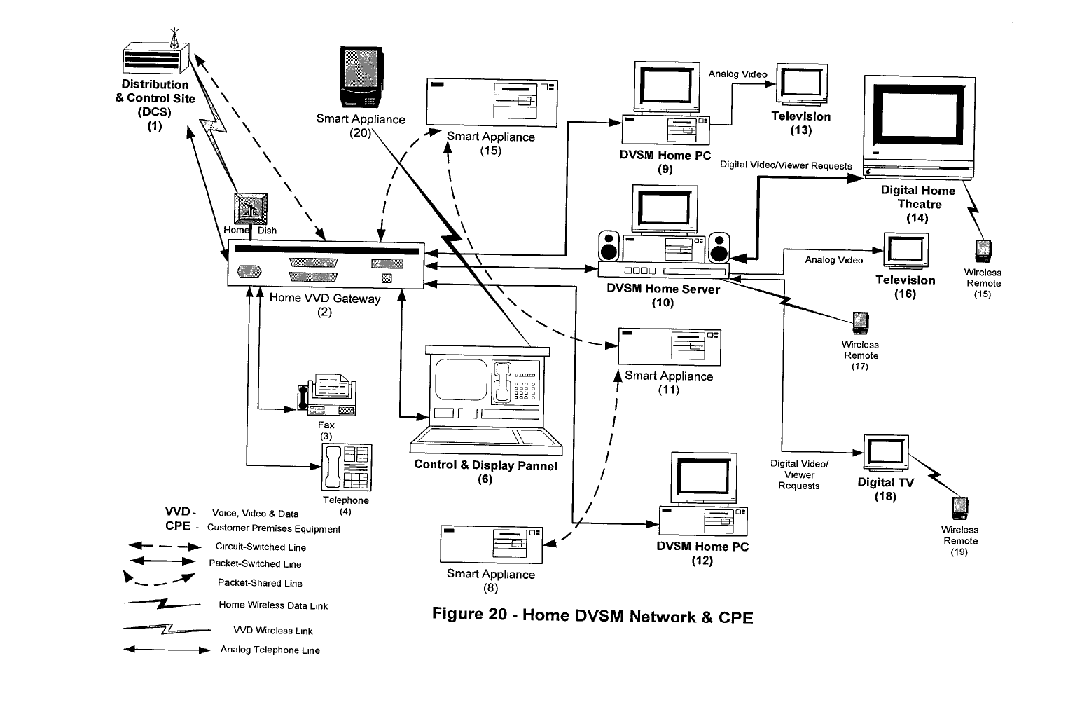

FIG. 20 is a representation of the interface for the voice, video and data gateway module of the system of FIG. 11 according to a preferred embodiment of the present invention. Illustrated is a system comprising of a local area network at the CPE. Distribution Control Site (1) can transmit or receive voice, video or data signals via circuit switched line, packet switched line, or by a wireless link to and from the Home VVD Gateway (2). Within the CPE, fax (3), telephone (4), Smart Appliance (5), Control and Display Panel (6), DVSM Home PC (9) and DVSM Home Server (10) are connected via wireline or wireless links.

The local area network is fully bi-directional. Smart Appliances (5), (8) and (11) are wirelessly linked to each other and Smart Appliance (7) is wirelessly linked to the Control and Display Panel (6). DVSM Server (10) is linked to the Digital Home Theater (14), Television (16), wireless remote (17) and digital TV (18), which is wirelessly linked to wireless remote (19). The Digital Home Theater (14) is wirelessly linked to a wireless remote (15). The invention anticipates sophisticate local area network and provides the capacity the accommodate such a CPE network.

The system and method of the present invention supports a wide range of data and network protocols including industry standard data and network protocols. The servers and clients of the system and method of the present invention can be implemented using any operating system including, but not limited to, Unix, Linux, VMS, IBM, Microsoft Windows NT, 95, 98, 2000, and ME, and the like.

The systems, processes, and components set forth in the present description may be implemented using one or more general purpose computers, microprocessors, or the like programmed according to the teachings of the present specification, as will be appreciated by those skilled in the relevant art(s). Appropriate software coding can readily be prepared by skilled programmers based on the teachings of the present disclosure, as will be apparent to those skilled in the relevant art(s).

IV. Applications of the Invention and Other Embodiments

DVSM technology has immediate application in a plurality of business segments or circumstances. Additionally it creates new business opportunities that present technologies cannot exploit or are severely disadvantaged in exploiting without the use of DVSM. DVSM techniques enhance and enable many new yet to be discovered future applications.

With existing technologies iTV has had limited success. Technically, cable TV networks and telephone networks have been able to deploy equipment that has successfully allowed users to interact with the network for applications such as pay-per-view, poling and merchandise purchasing. However, universal and ubiquitous deployment has been severally retarded because of technical and economic limitations. Using DVSM technology, Microcasting provides the economic base to ubiquitously deploy iTV.

The need for extensive bandwidth and video streaming capacity required by existing technologies, create major obstacles to deploy VOD. Networks that use DVSM technology can cost effectively provide VOD services to any user, anywhere at any time within their network.

Videonet an application defined by the Invention, as a secure network of video-sites capable of delivering, a plurality of full-motion high-resolution video clips in response to a plurality of user requests within the Videonet. As a centralized system and unsecured node-hoping public network, the Internet is only able to deliver text and low-resolution images. DVSM technology enables video-sites to provide high-resolution video presentations of products or services requested by a plurality of users.

Micro advertising as defined by the invention is the ability of the Videonet to deliver a unique advertisement for each individual viewer. The worldwide implementation of DVSM technology on cable or wireless networks will revolutionize the advertisement industry.

Micro-Commerce as defined by the Invention is a “market” or “marketplace” where sellers can use full motion video to present buyers their products and/or services based upon the individual user's specifically stated or unstated wants, wishes, desires, and psychodynamic and demographic needs. DVSM technology enables network operators to create these markets using Micro-advertising and the Videonet.

Hand held wireless devices such as Personal Digital Assistants (PDAs), telephones and laptop Computers communicate using a wireless network. At present, these wireless networks are limited to transmitting voice and data. The next generation hand held devices under development in labs of leading manufacturers will be capable of displaying full-motion video. This technology evolution would require wireless networks capable of transmitting video clips to millions of people worldwide. Since the wireless networks are severely limited by the available bandwidth, DVSM technology would become very valuable to increase the efficiency of the spectrum.

The current version of Internet (I) is suitable for transmitting only low speed data. Some experiments to transmit voice have proven the serious bandwidth limitations of Internet. The worldwide popularity of Internet (I) has led to the development of Internet II, which would be capable of transmitting data to users in Megabits/sec, compared to kilobits/sec. When fully deployed, Internet II would create user demand for high-resolution video content (similar to HDTV) to be delivered to their mobile devices. DVSM technology would become highly valuable, since it uses only a fraction of the bandwidth to deliver full-motion video, as compared to Video Streaming technologies.

Important to underscore Microcasting, how it differs from broadcasting and Narrowcasting and the impact it will have on television viewing in general and eventually on television and cable television revenue, is a need to understand the fundamental impact cable TV had on broadcast television.

Over the air broadcasting is totally advertising supported. It derives its revenue from selling advertisement placement to potential advertisers on a run of station (ROS) or fixed position basis. ROS placement is less expensive to the advertiser because the station controls where, when and how the advertisement will be placed throughout the various day-parts. Fixed position advertising is much more expensive to the advertiser because the advertiser is guaranteed a specific time, program, and position. Advertisement placement pricing is developed by the number of viewers (ratings) estimated to be watching a particular program at a particular time. Television ratings as calculated by the A. C. Nielsen Company are a statistical estimated percent of viewers watching television programs. These estimates are developed by the use of a number of devices (developed throughout the years) attached to television sets to record minute-by-minute viewing. In addition, Nielsen households maintain audio logs, which are diaries indicating viewing habits. Audience share directly affects the price of a particular ad placement.

Until several years ago the A. C. Nielsen Company was not measuring cable TV programming. Cable programming is highly segmented with viewers disbursed throughout individual cable channels. Nielsen's technology is under development to include the highly segmented cable channels. As cable programming has improved, viewer migration trends have been detected and are affecting the ratings of off air network broadcasters. Put simply more and more viewers are watching less and less off-air broadcast programming.

Network revenues are going down and off-air broadcast networks are themselves segmenting viewing audiences by launching cable-programming channels. The net effect is that Narrowcasting has devalued broadcast programming by stealing away audience and Microcasting will do the same to Narrowcasting.

Over the last decade the most profound business phenomena has been the Internet. Every type of business is rushing to get on the net and technology is moving quickly toward migrating or expanding the Internet from the computer to the television. Web TV, Worldgate and others are presently providing Internet access via the television screen. Originally, the Internet was a network of computers put together by the United States' Defense Advanced Research Projects Agency (DARPA), linking seven university science departments thus allowing its users to exchange messages and research with each other. Since its original inception it has now grown to possibly 2 million host computers all over the world and continues to grow. These massive numbers of host computers create a roadblock to smooth video streaming.

Architecturally the Internet is a shared packet data network. This type of transmission is best used for low bandwidth burst-type data applications. Smooth full-motion video, continuity and bandwidth are the major issues in terms of moving video programming. Node hopping is the method used to move data on the Internet. A difficulty in synchronizing the arrival of each data packet disrupts video continuity making it difficult or impossible to achieve MPEG 2-video quality. Standard (MPEG 2 is the standard approved by the FCC for broadcasting digital TV) quality video program streaming requires a dedicated transmission of a minimum 3.2 megabits per second.

Television viewing, as an experience is very different from the viewing experience users have on the Internet. Internet web sites principally offer static data in text or object form. Occasionally text data is augmented with sound and/or animation. Sometimes, on rare instances, web sites make an attempt at full motion video streaming. These attempts result in choppy pictures, poor picture quality and sound synchronization and in general a very poor video experience. DVSM will have a very positive impact on the viewing experience for Internet type web sites. As more and more of the existing and new cable TV and communications networks deploy DVSM, a new Video Internet (Videonet) will emerge. Internet Service Providers will have the ability to Microcast from prerecorded high-resolution video web sites over this new Videonet. These video web sites will be able to provide video clips of services, advertising video clips, and detailed product explanations and provide their customers a full motion video experience.

Technology may at sometime be developed to improve on-screen resolution, data throughput, return path transportation and all other elements that are needed to make television viewing interactive and behave more like the Internet. But these technologies do not address the allocation of bandwidth or the fundamental definition of DVSM.

Embedded in Internet interactivity are navigational techniques and technologies that make it functional. New navigational techniques and technologies developed within the Invention will provide television the building blocks for further segmentation of programming content thus migrating broadcasting and present day Cablecasting viewers to services offered by Multi Channel Video Programming Distributors who have adopted DVSM.

Both broadcasting and cable TV programmers predetermine what and when viewers will have access to specific programming. Regardless of which media, viewing television today is by appointment. In the Microcasting world, viewers will determine how, what and when they will access specific programming based on their individual tastes, wishes, or desires. Appointment television producers will transition from pre-produced channels (day-part general programming or by genre) to individual content production, operating within the framework of a Microcasting network because viewers will be able to use navigation tools to select and self-produce their own interactive television viewing.

DVSM technology will enable Multi-Channel Video Programming Distributors to more narrowly define and segment the television audience. This viewer segmentation will be accomplished by delivering individualized programming from a variety of local community networks. DVSM technology will give birth to many new applications that would enhance the life-style of human society forever.

The foregoing has described the principles, embodiments, and modes of operation of the present invention. However, the invention should not be construed as being limited to the particular embodiments described above, as they should be regarded as being illustrative and not as restrictive. It should be appreciated that those may make variations in those embodiments skilled in the art without departing from the scope of the present invention.

While a preferred embodiment of the present invention has been described above, it should be understood that it has been presented by way of example only, and not limitation. Thus, the breadth and scope of the present invention should not be limited by the above-described exemplary embodiment.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent is:

1. A system for management, transmission, and control of video data comprising:
at least one server device for storing video data as video segments and for asynchronously transmitting said stored video segments in response to user requests;
at least one client device for receiving video segments and storing said received video segments for processing and isochronously displaying said received video segments to a user on a display device; and
a communications network for transporting said video data, wherein said at least one server device and said at least one client device are coupled to said communications network,
wherein each of said video segments includes a set of assigned attributes and video content, said assigned attributes representing control codes and instructions enabling transport, processing, and display of a video segment based solely on said set of attributes without reference to any other video segment.

2. The video data management, transmission, and control system according to claim 1, wherein said video segments are variable length segments.

3. The video data management, transmission, and control system according to claim 1, wherein said control codes and instructions of said attributes includes one or more of the following codes or instructions: segment transmission instructions, authorized movie ratings instructions, coordination of viewing sequence, overwrite instructions, web linking instructions, transmission sequence instructions, ad selection and insertion instructions, branching instructions, formatting codes, transmission codes, communications codes, interactive element codes, web link codes, storage location codes, and viewing sequencing codes.

4. The video data management, transmission, and control system according to claim 1, wherein said control codes and instructions of said attributes identify specific designates including one or more of the following: users, locations, links, and server and client activities.

5. The video data management, transmission, and control system according to claim 1, wherein each of said video segments transported includes a user address and wherein said at least one server device dynamically assigns multiple user addresses to video segments to synchronize user requests with video segment transmissions.

6. The video data management, transmission, and control system according to claim 1, wherein said video data represents a video program and each of said video segments viewed in sequence represents the complete video program, wherein said at least one server device transmits said video segments in sequence.

7. The video data management, transmission, and control system according to claim 1, wherein said video data represents a video program and each of said video segments viewed in sequence represents the complete video program, wherein said at least one server device transmits said video segments out of sequence.

8. The video data management, transmission, and control system according to claim 1, wherein said video data represents a video program and each of said video segments viewed in sequence represents the complete video program, wherein said at least one client device receives said video segments in sequence.

9. The video data management, transmission, and control system according to claim 1, wherein said video data represents a video program and each of said video segments viewed in sequence represents the complete video program, wherein said at least one client device receives said video segments out of sequence.

10. A method for management, transmission, and control of video data in a system including a plurality of server devices, a plurality of client devices, and a communications network for transporting video data, each of said server devices and each of said client devices being coupled to said communications network, said method comprising the steps of:
segmenting video program data into a plurality of video segments, each video segment being assigned a set of attributes representing control codes and instructions for enabling transport, processing, and display of said plurality of video segments to a plurality of users;
storing said plurality of video segments in said plurality of server devices;
asynchronously transmitting at least one stored video segment from one of the server devices through the communications network to one of the client devices in response to a request by a user of the one client device;
receiving said at least one video segment in the client device;
storing the received video segment in the client device; and
isochronously displaying the received video segment on a display device coupled to the client device,
wherein the transmission, processing, and display of the video segment is based solely on the set of attributes without reference to any other video segment.
